(19) United States
(12) Patent Application Publication
(10) Pub. No.: US 2026/0277872 A1
(43) Pub. Date: Sep. 17, 2026

(54) BLOCKCHAIN NODE AND TRANSACTION INFORMATION PROCESSING METHOD APPLIED TO BLOCKCHAIN NODE

(71) Applicant: TENCENT TECHNOLOGY (SHENZHEN) COMPANY LIMITED, Shenzhen (CN)

(72) Inventors: Guanghong LU, Shenzhen (CN); Zhihong CAI, Shenzhen (CN)

(21) Appl. No.: 19/672,672

(22) Filed: May 10, 2026

Related U.S. Application Data
(63) Continuation of application No. PCT/CN2025/076884, filed on Feb. 11, 2025.

(30) Foreign Application Priority Data
Mar. 6, 2024 (CN) 202410261087.1

(51) Int. Cl. G06F 16/23

(52) U.S. Cl. CPC G06F 16/2343

(57) ABSTRACT

A transaction information processing method applied to a blockchain node. The method includes receiving, by the scheduling module, a transaction information transmission request requesting the transaction pool module to start transmitting transaction information; determining, in response to the transaction information transmission request, a plurality of pieces of transaction information; and writing, when a transaction queue for transmitting the plurality of pieces of transaction information comprises a first-type read queue and a first-type write queue, the plurality of pieces of transaction information into the first-type write queue. The first-type write queue is subject to a write lock constraint allowing only a single thread to perform a write operation on transaction information. The first-type read queue allows a plurality of threads to perform a read operation in parallel on transaction information of the plurality of pieces of transaction information at a same moment.

### RELATED APPLICATIONS

This application is a continuation of PCT Application No. PCT/CN2025/076884, filed on Feb. 11, 2025, which claims priority to Chinese Patent Application No. 2024102610871, filed on Mar. 6, 2024, and entitled “BLOCKCHAIN NODE AND TRANSACTION PROCESSING METHOD APPLIED TO BLOCKCHAIN NODE”, which are both incorporated herein by reference in their entirety.

### FIELD OF THE TECHNOLOGY

This application relates to the field of blockchain technologies, and in particular, to a blockchain node and a transaction information processing method applied to a blockchain node.

### BACKGROUND OF THE DISCLOSURE

In a blockchain system, after obtaining new transaction information, a blockchain node first temporarily stores the new transaction information in a cache pool module of the blockchain node. When preparing to generate a new block, the blockchain node selects a particular amount of transaction information from the transaction pool module for processing and packaging.

In a many blockchain systems, a transaction pool module transmits a plurality of pieces of transaction information that needs to be packaged into a new block to a virtual machine engine of a blockchain node in a manner of a single queue. For example, the transaction pool module writes the transaction information into the queue, and the virtual machine engine reads and processes the transaction information from the queue. In addition, to protect synchronization and consistency of transaction information in a queue, when transaction information is transmitted, a read-write lock is usually added to the transaction information. However, in this way, a problem of a read-write lock conflict is caused. That is, a write lock needs to be held when the transaction information is written into the queue, and a read lock needs to be held when the transaction information is read from the queue. When a write thread occupies the write lock and writes the transaction information into the queue, other write threads and read threads have to wait; and when the read thread occupies the read lock and reads the transaction information from the queue, the write threads have to wait. As such, read-write congestion of the transaction information is easily caused, and transmission efficiency of the transaction information in a blockchain node is not high.

### SUMMARY

This application provides a blockchain node and a transaction information processing method applied to a blockchain node.

According to an aspect of embodiments of this application, a transaction information processing method applied to a blockchain node is provided. The blockchain node includes a scheduling module, a transaction pool module, and a virtual machine engine. The method includes: receiving, by the scheduling module, a transaction information transmission request requesting the transaction pool module to start transmitting transaction information; determining, in response to the transaction information transmission request, a plurality of pieces of transaction information stored in the transaction pool module; and writing, when a transaction queue for transmitting the plurality of pieces of transaction information comprises a first-type read queue and a first-type write queue, the plurality of pieces of transaction information into the first-type write queue.

The first-type write queue is subject to a write lock constraint allowing only a single thread to perform a write operation on transaction information of the plurality of pieces of transaction information at a same moment. The first-type read queue allows a plurality of threads to perform a read operation in parallel on transaction information of the plurality of pieces of transaction information at a same moment. The first-type read queue is configured for the virtual machine engine to read transaction information of the plurality of pieces of transaction information and perform transaction processing on the plurality of pieces of transaction information to obtain processing results. The plurality of pieces of transaction information and the processing results are configured for instructing the scheduling module to package the plurality of pieces of transaction information into a new block based on the processing results.

A second aspect of embodiments of this application provides a transaction information processing method applied to a blockchain node is provided. The blockchain node includes a scheduling module, a transaction pool module, and a virtual machine engine. The method includes: reading, when a transaction queue configured for transmitting transaction information comprises a first-type read queue and a first-type write queue, a plurality of pieces of transaction information from the first-type read queue. The first-type read queue allows a plurality of threads to perform a read operation in parallel on transaction information of the plurality of pieces of transaction information at a same moment, the plurality of pieces of transaction information in the first-type write queue being written by the transaction pool module, the first-type write queue being subject to a write lock constraint. The first-type write queue subject to the write lock constraint allows only a single thread to perform a write operation on transaction information of the plurality of pieces of transaction information at a same moment.

The method further includes performing transaction processing on the plurality of pieces of transaction information, to obtain processing results corresponding to the plurality of pieces of transaction information; and transmitting the plurality of pieces of transaction information and the processing results to the scheduling module, the plurality of pieces of transaction information and the processing results being configured for instructing the scheduling module to package the plurality of pieces of transaction information into a new block.

According to an aspect of the embodiments of this application, a non-transitory computer-readable storage medium is provided. The storage medium has a computer program stored therein, and the computer program is loaded and executed by a processor to implement the foregoing transaction information processing method applied to a blockchain node.

The details of one or more embodiments of this application will be provided in the accompanying drawings and descriptions below. Other features, objectives, and advantages of this application become apparent from the specification, the accompanying drawings, and claims.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other accompanying drawings from these accompanying drawings without creative efforts.

FIG. 1 is a schematic diagram of a solution implementation environment according to an embodiment of this application.

FIG. 2 is a schematic diagram of a blockchain node according to an embodiment of this application.

FIG. 3 is a schematic diagram of an interaction relationship between modules in a blockchain node according to an embodiment of this application.

FIG. 4 is a flowchart of a transaction information processing method applied to a blockchain node according to an embodiment of this application.

FIG. 5 is a schematic diagram of a transaction queue according to an embodiment of this application.

FIG. 6 is a flowchart of a method for determining a write position of transaction information according to an embodiment of this application.

FIG. 7 is a schematic diagram of a first-type write queue according to an embodiment of this application.

FIG. 8 is a schematic diagram of a first-type write queue according to another embodiment of this application.

FIG. 9 and FIG. 10 are schematic diagrams of a method for switching between a first-type read queue and a sub-queue according to an embodiment of this application.

FIG. 11 is a flowchart of a transaction information processing method applied to a blockchain node according to another embodiment of this application.

FIG. 12 is a flowchart of a method for transmitting a processing result according to an embodiment of this application.

FIG. 13 is a schematic diagram of a result queue according to an embodiment of this application.

FIG. 14 is a schematic diagram of a second-type write queue according to an embodiment of this application.

FIG. 15 is a flowchart of a transaction information processing method applied to a blockchain node according to another embodiment of this application.

FIG. 16 is a flowchart of a method for switching between a read queue and a write queue according to an embodiment of this application.

FIG. 17 is a block diagram of a structure of a computer device according to an embodiment of this application.

### DESCRIPTION OF EMBODIMENTS

The technical solutions in embodiments of this application are clearly and completely described in the following with reference to the accompanying drawings in embodiments of this application. Apparently, the described embodiments are merely some rather than all of the embodiments of this application. All other embodiments obtained by a person of ordinary skill in the art based on the embodiments in this application without making creative efforts still fall within the scope of protection of this application.

To make objectives, technical solutions, and advantages of this application clearer, the following further describes implementations of this application in detail with reference to accompanying drawings.

First, terms involved in this application are described.

The blockchain technology is a distributed ledger technology in the field of information technologies, and generally includes content such as a consensus, a transaction block, state data storage, and cryptographic identity security. Because a ledger is stored in a distributed manner, and has blocks reaching a consensus, the ledger has features such as being tamper-proof, traceable, and maintained together (the ledger packages transaction information into blocks, and links the blocks together in a cryptographic manner, to form a tamper-proof chain (that is, a blockchain), and each block includes a transaction record and a hash value of a previous block).

A blockchain system may be a distributed system implemented based on the blockchain technology. The blockchain system can include a blockchain underlying platform, a platform product service layer, and an application service layer. The blockchain system may also be referred to as a blockchain network.

The underlying blockchain platform may include processing modules such as a user management module, a basic service module, a smart contract module, and an operation management module. The user management module is responsible for managing identity information of all blockchain participants, including maintaining public and private key generation (account management), key management, maintenance of a correspondence between a real identity of a user and a blockchain address (permission management), supervising and auditing of transaction statuses of some real identities when authorized, and providing rule configuration for risk control (audit). The basic service module is deployed on all blockchain node devices to verify the validity of a service request (that is, transaction information), and records a valid request to a storage after completing consensus. For a new service request, a basic service first performs interface adaptation parsing and authentication processing (interface adaptation), then encrypts service information through a consensus algorithm (consensus management), completely and consistently transmits the new service request to a shared ledger (network communication) after encryption, and records and stores the new service request. The smart contract module is responsible for registration and issuance of a contract, as well as contract triggering and contract execution. A developer may define contract logic through a programming language, publish the contract logic to the blockchain system (contract registration), according to logic of a contract term, call a key or other events to trigger execution, complete the contract logic, and further provide functions of contract upgrade and cancellation. The operations management module is mainly responsible for deployment, configuration modification, contract setting, and cloud adaptation during product release, and visualized output of a real-time state during product operation, for example: alarming, network status management, and node device health state management.

The platform product service layer provides basic capabilities and an implementation framework of a typical application. Based on these basic capabilities, developers may superpose characteristics of services and complete blockchain system implementation of service logic. The application service layer provides an application service based on a blockchain solution to service participants for use.

A blockchain is a core data structure in the blockchain system, and is a new application mode of a computer technology such as distributed data storage, point-to-point transmission, a consensus mechanism, and an encryption algorithm. The blockchain is essentially a decentralized database, and is a string of a data block (that is, a block) generated in a cryptographic manner. Each data block includes information about a batch of network transactions (that is, transaction information), which is configured to verify validity of the information (anti-counterfeiting) and generate a next block. For example, the blockchain may be configured to store and manage all confirmed blocks. The blockchain is organized in a chain structure, and each block includes a group of transactions, a block header (including metadata such as a hash value and a time stamp of a previous block), and other information. The blockchain provides a public and tamper-proof transaction history record for the blockchain system, thereby ensuring transparency and consistency of the blockchain system. The blockchain may also be referred to as a block ledger.

The blockchain includes a series of blocks that are consecutive in a sequence of generation time. Once a new block is added to the blockchain, the new block is no longer removed. A block includes a block header and a block body. The block header includes: a version number of the block, a root hash, a time stamp configured for representing block creation, a difficulty value (Target_bits), and a random number (Nonce). The block body records transaction information in the block, and the transaction information may be arranged according to a Merkle tree structure. The root hash generally refers to a hash value of a root node of a Merkle Tree. The Merkle tree is a binary tree structure, and is configured for efficiently verifying integrity of a large amount of data. The root hash is obtained by recursively calculating hash values of nodes in the tree. Starting from leaf nodes, each leaf node stores a hash value of a data block (for example, transaction information). Hash values of two adjacent leaf nodes are combined, and then hash calculation is performed to obtain a hash value of a parent node of the leaf nodes. This process is repeated until the hash value of the root node, that is, a root hash, is finally obtained. In the blockchain, the root hash is included in the block header. By verifying the root hash, the node can quickly check integrity of transaction information in an entire block. If any transaction is tampered, the structure of the Merkle tree changes, and the root hash also changes accordingly, so that inconsistency of data can be easily detected.

The Merkle tree is a binary tree constructed by hash values of a group of data blocks. A leaf node of the tree is a hash value of each data block, a non-leaf node is a hash value obtained after hash values of two child nodes thereof are combined, and a hash value of a final root node is a root hash. When the Merkle tree is constructed, first, hash calculation is separately performed on all to-be-processed data blocks, to obtain hash values of leaf nodes; then, hash values of adjacent leaf nodes are combined in pairs, and hash calculation is performed, to obtain a hash value of a node at a previous layer; and this process is repeated until a root node is generated. Due to a structural feature thereof, a small change of any data block causes all hash values starting from a leaf node corresponding to the data block to a root node to change. Therefore, whether an entire data set has been tampered can be determined by only verifying whether a root hash is correct. In a blockchain, transaction information in a block body may be arranged according to a Merkle tree structure, to ensure integrity and security of the transaction information.

The random number (Nonce) is any number included in the block header, and is usually a 32-bit or 64-bit integer. Although the patent does not describe a specific action mechanism of the random number in this system in detail, in a general blockchain concept, the random number plays a key role in a Proof of Work (PoW) consensus mechanism. A miner needs to continuously try different random numbers and perform hash calculation on the random numbers and other information (for example, a hash value of a previous block or a root hash of transaction information) in the block header until a result satisfying a particular condition (for example, a hash value is less than a target value) is obtained. The miner finding a suitable random number obtains a block reward and adds a new block to the blockchain.

After the transaction information is generated, the transaction information is stored in a Transaction Pool (also referred to as memory pool or mempool) module of the blockchain node. The transaction pool module refers to a memory space configured for caching transaction information inside a blockchain node program. The transaction information in the transaction pool module has not been written into a block ledger (that is, a blockchain) yet. For any piece of transaction information in the transaction pool module, it only indicates that the blockchain node has received the transaction information. When a block needs to be generated subsequently, the blockchain node takes a batch of transaction information from the transaction pool module, and deletes the batch of transaction information from the transaction pool module, to form a block by using the batch of transaction information. For example, the transaction pool module is a data structure in the blockchain system, and is configured to store transaction information that has not been packaged into a block. When a user submits new transaction information to the blockchain network, the transaction information first enters the transaction pool module. When preparing to generate a new block, the blockchain node selects a particular amount of transaction information from the transaction pool module for packaging. The transaction pool module helps improve a processing capability of the blockchain network, and may also be used as a policy to enable a blockchain node to select transaction information having relatively high commission for packaging, thereby improving benefits of the blockchain node.

A smart contract is a computer protocol designed to propagate, verify, or execute contacts in a digital manner. The smart contract permits trusted transactions to be performed without a third party, and these transactions are traceable and irreversible. For example, the smart contract may be implemented as a program that is stored in a blockchain and that is automatically executed when a preset condition is satisfied, for example, all operations in the protocol or the contract are automatically executed. The smart contract is mainly configured for executing a transaction and accessing state data. For example, a logistics state of a commodity purchased by a buyer is searched for, and electronic money of the buyer is transferred to an address of a merchant after the buyer signs for the commodity. Certainly, the smart contract is not limited to a contract for executing a transaction, but may alternatively be a contract for processing received information.

The state data is a data structure configured for representing a current state of the system in the blockchain system. The state data includes balances of all accounts, states of smart contracts, and other related information. The state data is continuously updated as the transaction is executed, and reflects a global state of the blockchain system at a time point. In the blockchain system, state data is usually stored in a form of a Merkle tree or another encrypted data structure, to ensure integrity and security of the state data. For example, the state data may be stored in a state database, and the state database may be configured to store full state data of the blockchain system.

A read-write set refers to a group of data items involved in a process of performing a blockchain transaction. The read-write set includes two parts: a read set (readset, which represents a data set that needs to be read to execute the transaction) and a write set (writeset, which represents a data set that needs to be written to store a processing result of the transaction). In a blockchain system, a read-write set is configured for recording a status of access and modification by a transaction to state data, to ensure correct execution of the transaction and data consistency. The read-write set may be generated after a smart contract is executed according to the transaction information. The read-write set identifier is configured for identifying a read-write set, and may be recorded as a read-write set key.

A transaction is an operation request of a user on a smart contract deployed on the blockchain. The transaction information is information configured for describing a transaction, to refer to the transaction. The transaction is initiated by the user and is, for example, transmitted from a client of the user to a blockchain node (referred to as a master node) in the blockchain system. After receiving the transaction (for example, transaction information), the master node calls a corresponding smart contract according to a contract address and an interface that are specified by the transaction, and then notifies another blockchain node (referred to as a slave node) of the transaction. After receiving the transaction, the slave node calls the corresponding smart contract according to the contract address and the interface that are specified by the transaction, to process the transaction.

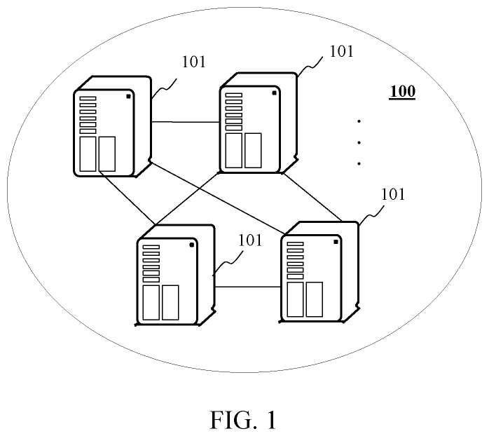

FIG. 1 is a schematic diagram of a solution implementation environment according to an embodiment of this application. The solution implementation environment may be implemented as a blockchain system. The blockchain system 100 may include a plurality of blockchain nodes 101.

A blockchain node 101 is a basic constituent unit of the blockchain system 100. The blockchain system 100 may include a plurality of blockchain nodes 101. There is a communication connection between the blockchain nodes 101, so that data transmission may be performed between any two blockchain nodes 101, for example, one node receives data (such as a block, transaction information, or a processing result) from the other node, or sends data to the other node.

The blockchain node 101 may be any form of computer device in an access network, such as a server or a user terminal. A peer-to-peer network is formed between the blockchain nodes 101. A peer-to-peer protocol is an application-layer protocol running over the Transmission Control Protocol (TCP). In the distributed system, any machine such as a server or a terminal device may be added to become a blockchain node. The blockchain node includes a hardware layer, an intermediate layer, an operating system layer, and an application layer.

The blockchain node 101 has at least functions such as transaction information processing, blockchain maintenance, consensus, receiving and sending, computation, and storage. For example, the blockchain node 101 may send transaction information to another node in the blockchain system 100, and perform operations such as transaction processing, consensus, and storage on the obtained transaction information. The transaction information processing may be transaction processing on the transaction information.

Functions of each blockchain node 101 in the blockchain system 100 include but are not limited to one of the following:

Routing: It is a basic function of the blockchain node 101, and is configured for implementing communication between the blockchain nodes 101.

Application: It is deployed in a blockchain system, and is configured for implementing a particular service according to an actual service requirement, recording data related to function implementation to form recorded data, adding a digital signature to the recorded data to represent a source of task data, and transmitting the recorded data to other nodes in the blockchain system, for the other nodes to add the recorded data to a temporary block when verifying the source and integrity of the recorded data successfully.

For example, services implemented by the application include: Shared ledger: It is configured for providing functions of operations such as storage, query, modification of account data, and transmitting recorded data of the operations on the account data to another node in the blockchain system. Another node stores, after verifying that the account data is valid, recorded data into a temporary block in response to admitting that the account data is valid, and may further transmit an acknowledgment to a blockchain node 101 initiating the operations.

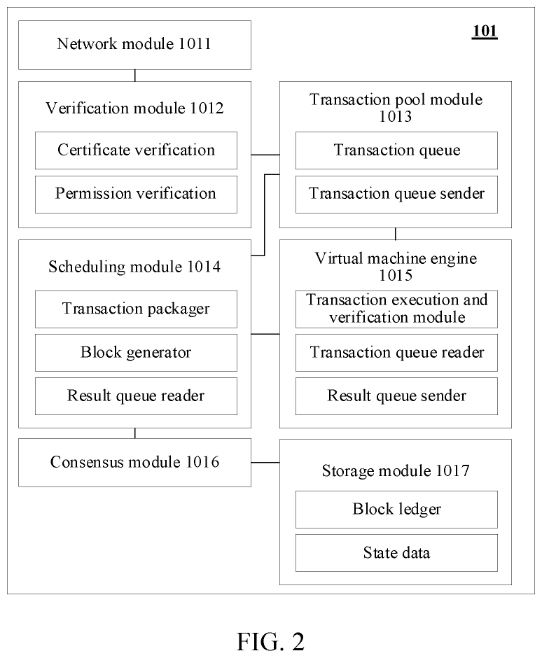

In an example, FIG. 2 is a schematic diagram of a blockchain node according to an embodiment of this application. The blockchain node 101 may be any blockchain node in the blockchain system, or may be a blockchain node in the blockchain system that is specially configured to perform transaction processing on transaction information. This is not limited in this embodiment. The blockchain node 101 may include a network module 1011, a verification module 1012, a transaction pool module 1013, a scheduling module 1014, a virtual machine engine 1015, a consensus module 1016, and a storage module 1017.

The network module 1011 is configured to be responsible for communication between blockchain nodes, has a routing function, and can implement data transmission between blockchain nodes, such as transaction information broadcast and block synchronization.

The verification module 1012 is configured to be responsible for performing certificate verification and permission verification on the transaction information. Certificate verification refers to a process of verifying an identity certificate of a transaction initiator that corresponds to transaction information, to ensure that an identity of the transaction initiator is legal. Permission verification refers to a process of verifying whether a transaction initiator has a permission to execute a transaction.

The transaction pool module 1013 is configured to store transaction information. The transaction pool module 1013 may include a transaction queue sender, and the transaction queue sender is configured to send the transaction information to the virtual machine engine 1015. In some embodiments, the transaction queue sender may alternatively be implemented independent of the transaction pool module 1013. This is not limited in this embodiment.

The scheduling module 1014 is configured to be responsible for packaging transaction information and generating a block. The scheduling module 1014 may include a transaction packager, a block generator, and a result queue reader. The transaction packager is configured to package processed transaction information into a block. The block generator is configured to generate a new block, which includes a block header and a block body. The result queue reader is configured to obtain a processing result of the transaction information from the virtual machine engine 1015.

The virtual machine engine 1015 is configured to be responsible for executing and verifying transaction processing on the transaction information. The virtual machine engine 1015 may include a transaction execution and verification module, a transaction queue reader, and a result queue sender. The transaction execution and verification module is configured to be responsible for performing transaction processing, to obtain a processing result, and verifying correctness of the processing result. The transaction queue reader is configured to obtain the transaction information from the transaction pool module 1013, and the result queue sender is configured to send the processing result of the transaction information to the scheduling module 1014. In some embodiments, the result queue sender may alternatively be implemented independent of the virtual machine engine 1015. This is not limited in this embodiment.

The consensus module 1016 is configured to be responsible for reaching a consensus on the block and the transaction information in the blockchain system, to ensure correctness and security of the blockchain. The consensus is a process of making distributed ledgers (that is, blockchains) between blockchain nodes in the blockchain system consistent.

The storage module 1017 is configured to be responsible for storing data of the blockchain, including a block ledger and state data. The block ledger is responsible for storing processed block data, and the state data is responsible for storing state information in the blockchain system, such as an account balance and smart contract data.

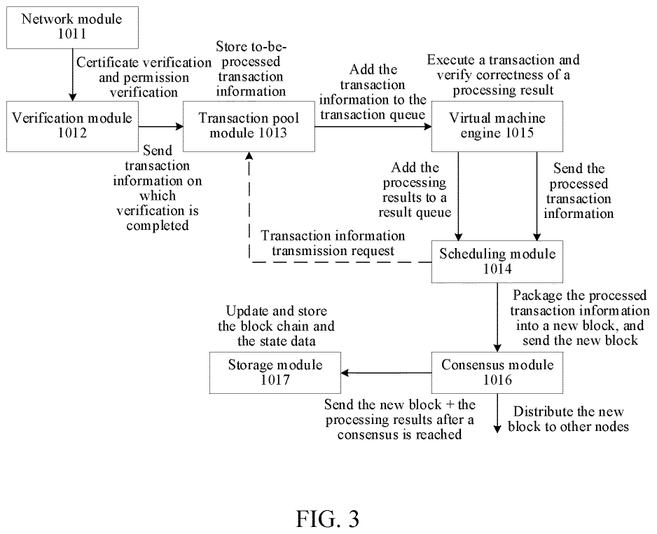

In an example, referring to FIG. 3, an interaction relationship between modules in the blockchain node 101 may be as follows:

The network module 1011 is communicatively connected to the verification module 1012, the verification module 1012 is communicatively connected to the transaction pool module 1013, the transaction pool module 1013 is communicatively connected to the virtual machine engine 1015 and the scheduling module 1014, the virtual machine engine 1015 is communicatively connected to the scheduling module 1014, the scheduling module 1014 is communicatively connected to the consensus module 1016, and the consensus module 1016 is communicatively connected to the storage module 1017.

After obtaining new transaction information, the network module 1011 sends the new transaction information to the verification module 1012 for certificate verification and permission verification, and the verification module 1012 sends transaction information that is successfully verified to the transaction pool module 1013 for storage. After receiving a transaction information transmission request from the scheduling module 1014, the transaction pool module 1013 adds a plurality of pieces of transaction information to be packaged into a new block to a transaction queue, to transmit the plurality of pieces of transaction information to the virtual machine engine 1015 by using the transaction queue. The virtual machine engine 1015 performs transaction processing on the plurality of pieces of transaction information, to obtain processing results of the plurality of pieces of transaction information, and adds the plurality of processing results to a result queue, to send the plurality of processing results to the scheduling module 1014 by using the result queue. In some embodiments, the virtual machine engine 1015 further sends the plurality of pieces of processed transaction information to the scheduling module 1014. The scheduling module 1014 packages the processed transaction information into a new block, and sends the new block and the processing results to the consensus module 1016. The consensus module 1016 distributes the new block to other blockchain nodes for consensus, and sends the new block and the processing results to the storage module 1017 after the consensus is completed. The storage module 1017 updates the blockchain (for example, adds the new block to the original blockchain) and the state data (for example, updates the state data according to the processing results) according to the new block and the processing results.

The technical solutions provided in the embodiments of this application are described below by using method embodiments. For content not described in the method embodiment, reference may be made to the foregoing embodiments.

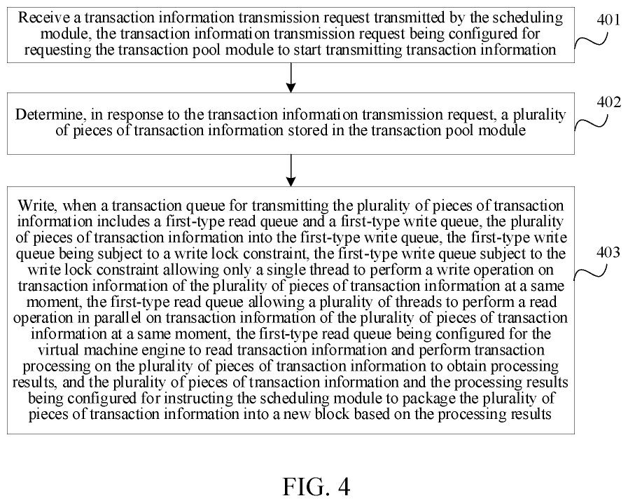

FIG. 4 is a flowchart of a transaction information processing method applied to a blockchain node according to an embodiment of this application. For example, the method may be performed by a blockchain node 101 in the solution implementation environment shown in FIG. 1, for example, a transaction pool module 1013 in the blockchain node 101. The blockchain node 101 includes a scheduling module 1014, a transaction pool module 1013, and a virtual machine engine 1015. As shown in FIG. 4, the method may include at least one of the following operations (401 to 403).

Operation 401: Receive a transaction information transmission request transmitted by the scheduling module, the transaction information transmission request being configured for requesting the transaction pool module to start transmitting transaction information.

The scheduling module is a module in the blockchain node, and is responsible for packaging transaction information and generating a block. The module may include a transaction packager, a block generator, and a result queue reader. The transaction packager is configured to package processed transaction information into a block. The block generator is configured to generate a new block, which includes a block header and a block body. The result queue reader is configured to obtain a processing result of the transaction information from the virtual machine engine. In addition, when determining that a new block needs to be generated, the scheduling module generates a transaction information transmission request, and instructs the transaction pool module to start transmitting the transaction information.

The transaction pool module refers to a memory space configured for caching transaction information inside a blockchain node program, and is configured to store the transaction information. The module may include a transaction queue sender, responsible for sending the transaction information to the virtual machine engine. The transaction pool module receives the transaction information transmission request transmitted by the scheduling module, determines a plurality of pieces of to-be-processed transaction information in response to the request, and then writes the pieces of transaction information into a first-type write queue in a transaction queue.

The transaction information is configured for describing a transaction in the blockchain system, and refers to information about an operation request of a user on a smart contract deployed on the blockchain. The transaction information may include an identity of the transaction information (TxID), attribute information of the transaction (such as a version number of a block to which the transaction belongs, specific transaction content, or a time stamp), and a purpose of the transaction information is determined according to the called smart contract. For example, transaction information calling a certificate contract may be configured for storing data, and transaction information calling a transfer contract may be configured for transfer, barter, or the like.

The transaction information transmission request is generated when the scheduling module determines that a new block needs to be generated. For example, the scheduling module may generate a new block according to a first time interval. For example, the scheduling module generates a new block every 10 s, 15 s, or the like. The scheduling module may generate a new block according to a first transaction quantity. For example, the scheduling module generates a new block every 2000 pieces of transaction information, 1500 pieces of transaction information, or the like. This is not limited in this embodiment.

A block is obtained by packaging a plurality of pieces of processed transaction information by the scheduling module. Transaction information is configured for describing a transaction in the blockchain system, and a transaction is an operation request of a user on a smart contract deployed on the blockchain. For example, the transaction information may refer to a representation manner of an operation performed in the blockchain. The purpose of the transaction information may be determined according to a smart contract called by the transaction information. For example, transaction information calling a certificate contract may be configured for storing data. For another example, transaction information calling a transfer contract may be configured for transfer or barter. For another example, transaction information calling a game contract may be configured for calling a game program. This is not limited in this embodiment.

In some embodiments, the transaction information includes an identity of the transaction information (TxID), attribute information of the transaction, and the like. The identity of the transaction information is also referred to as a transaction hash, and is configured for uniquely identifying the transaction information. The attribute information of the transaction includes a version number of a block to which the transaction information belongs, specific transaction content (such as a transaction input sequence and a transaction output sequence), and the like. In addition, the attribute information may further include a time stamp of the transaction information, to indicate a creation moment of the transaction information. The transaction hash is a length-fixed character string that is generated after the transaction information is processed by using a specific hash algorithm (such as SHA-256). The character string is a unique digital fingerprint of the transaction information, and the length of the hash value is fixed no matter how long or how short the content of the transaction information is. In a blockchain, a transaction hash is configured for uniquely identifying each transaction. When a user initiates a transaction, all details (such as an address of a sender, an address of a receiver, and a transaction amount) of the transaction are combined together, and a transaction hash is calculated by using a hash algorithm. Another node may quickly verify integrity and uniqueness of the transaction by using the hash value, to ensure that the transaction is not tampered during transmission and storage. In a blockchain network, when a transaction is packaged, a transaction hash is configured for identifying and organizing the transaction. When transaction information is synchronized between nodes, whether a transaction has been processed is also confirmed by relying on a transaction hash.

In some embodiments, the transaction information transmission request may include identification information of a plurality of pieces of to-be-processed transaction information to be packaged into a new block, for example, an identity of the transaction information, a creation time of the transaction information, or a root hash and a version number of the new block. For example, the scheduling module may determine a current packaging time period according to the first time interval, determine transaction information whose creation time is in the current packaging time period as the transaction information to be packaged into the new block, and then generate the transaction information transmission request based on the identity or the creation time of the transaction information, to notify the transaction pool module of transaction information which is to be sent. In some embodiments, the transaction information transmission request may further include a current packaging time period, and the transaction pool module may determine, according to the current packaging time period, the transaction information needing to be sent. This is not limited in this embodiment.

The transaction pool module has transaction information stored therein, and the transaction information is configured for indicating a to-be-executed transaction. The transaction information may be transaction information that is received by the blockchain node and that is sent by another blockchain node. Alternatively, the transaction information may be transaction information collected by the blockchain node. The transaction information collected by the blockchain node may be transaction information generated by the blockchain node. The transaction information may alternatively be transaction information sent by a transaction initiator to the blockchain node by using a terminal device. This is not limited in this embodiment.

Operation 402: Determine, in response to the transaction information transmission request, a plurality of pieces of transaction information stored in the transaction pool module.

In some embodiments, the transaction pool module determines the plurality of pieces of transaction information based on the identity in the transaction information transmission request, or may determine the plurality of pieces of transaction information based on the creation time in the transaction information transmission request, or may determine the plurality of pieces of transaction information based on the current packaging time period in the transaction information transmission request. This is not limited in this embodiment.

In a feasible example, the transaction information transmission request is only configured for requesting the transaction pool module to start transmitting the transaction information. Specifically, which transaction information is sent may be determined by the transaction pool module. For example, transaction information having an earlier creation time is sent, to improve timeliness of processing the transaction information.

Operation 403: Write, when a transaction queue for transmitting the plurality of pieces of transaction information includes a first-type read queue and a first-type write queue, the plurality of pieces of transaction information into the first-type write queue, the first-type write queue being subject to a write lock constraint, the first-type write queue subject to the write lock constraint allowing only a single thread to perform a write operation on transaction information of the plurality of pieces of transaction information at a same moment, the first-type read queue allowing a plurality of threads to perform a read operation in parallel on transaction information of the plurality of pieces of transaction information at a same moment, the first-type read queue being configured for the virtual machine engine to read transaction information and perform transaction processing on the plurality of pieces of transaction information to obtain processing results, and the plurality of pieces of transaction information and the processing results being configured for instructing the scheduling module to package the plurality of pieces of transaction information into a new block based on the processing results.

In this embodiment, the transaction queue is a queue configured for transmitting transaction information, for example, a queue configured for transmitting transaction information between the transaction pool module and the virtual machine engine. The queue is a data structure. The transaction queue in this embodiment is different from a common queue, and may include a first-type read queue and a first-type write queue. The first-type read queue refers to a queue configured for reading transaction information, and is not configured for writing transaction information. The first-type write queue refers to a queue configured for writing transaction information, and is not configured for reading transaction information. The first-type read queue is not connected to the first-type write queue.

Transaction processing refers to a process in which transaction information is processed (that is, a transaction is executed) by using the smart contract corresponding to the transaction information, and a processing result is obtained. In a blockchain system, transaction information initiated by a user is received by a blockchain node, a virtual machine engine calls a corresponding smart contract according to the transaction information, executes logic defined in the contract, completes a transaction operation, and generates a processing result. The processing result may be configured for updating state data in the blockchain system.

The virtual machine engine is responsible for executing and verifying transaction processing on the transaction information. The module may include a transaction execution and verification module, a transaction queue reader, and a result queue sender. The transaction execution and verification module is configured to perform transaction processing, to obtain a processing result, and verifying correctness of the processing result. The transaction queue reader is configured to obtain the transaction information from the transaction pool module, and the result queue sender is configured to send the processing result of the transaction information to the scheduling module.

Lock constraint is a mechanism configured for protecting synchronization and consistency of a shared resource, and blockchain transaction processing mainly involves a read-write lock constraint. Under a write lock constraint, only a single thread is allowed to perform a write operation on a resource subject to a constraint (for example, a first-type write queue or a second-type write queue) at the same moment, to avoid the problem of data inconsistency. A read lock usually allows a plurality of threads to perform read operations on a resource simultaneously. By properly setting a lock constraint, transmission efficiency of transaction information and a processing result between different modules of a blockchain node can be improved.

Packaging refers to a process in which a scheduling module integrates a plurality of pieces of processed transaction information to form a new block based on a processing result obtained by performing transaction processing on transaction information by the virtual machine engine. The new block includes a block header and a block body, the transaction information is added to the block body of the new block, and after the consensus is completed, the new block is added to the blockchain in the blockchain system. After determining that a new block needs to be generated, the scheduling module constructs a block header and a block body of the new block. After transaction processing is performed on the plurality of pieces of transaction information, the scheduling module may package the plurality of pieces of transaction information into the block body of the new block.

In some embodiments, the first-type write queue is subject to a write lock constraint, and the first-type read queue is not subject to a lock constraint. The write lock is a write-lock in a read-write lock (a spin lock), there is only one read-write lock, and the write lock is a read-write lock performing locking in a write mode. The read-write lock is a synchronization primitive configured for protecting a shared resource, and allows a plurality of threads to simultaneously read the shared resource (a read lock), but allows only a single thread to perform a write operation (a write lock) when writing into the resource. The read-write lock can ensure that during a write operation, other threads cannot perform a read-write operation on the shared resource, thereby avoiding the problem of data inconsistency. During blockchain transaction processing, a read operation usually does not modify data. Therefore, the first-type read queue is designed to not be subject to the lock constraint, to avoid waiting caused by a read-write lock conflict. This design improves concurrency of a read operation, so that the virtual machine engine can read in parallel, reduce transaction processing time consumption, improve a capability of the blockchain node to in parallel process a large quantity of transactions, and enhance overall system performance.

Because the first-type write queue is subject to a write lock constraint, and the first-type read queue is not subject to a lock constraint, the virtual machine engine may read transaction information in the first-type read queue by using threads in parallel, without occupying a read lock, and without waiting for the write lock corresponding to the first-type write queue to be released, thereby improving efficiency of reading the transaction information. However, the transaction pool module only needs to occupy the write lock and sequentially writes the transaction information into the first-type write queue, and does not need to wait for the read lock (the first-type read queue is not subject to a lock constraint) to be released, thereby improving the efficiency of writing the transaction information, and effectively improving the efficiency of transmitting the transaction information between the transaction pool module and the virtual machine engine.

In a feasible example, a process in which the virtual machine engine performs transaction processing on a plurality of pieces of transaction information to obtain processing results is as follows: The virtual machine engine performs transaction processing on the read transaction information by using the smart contract corresponding to the transaction information, to obtain the processing results of the transaction information. Transaction processing is performed on each piece of transaction information in the same transaction group (that is, write area) by using the same smart contract. Transaction processing needs to be performed on transaction information in different transaction groups by switching to corresponding smart contracts. Because the transaction information is sorted according to the contract name and the arrival time, such a practice can reduce switching costs of the smart contract, and reduce response time consumption during switching of the smart contract. The virtual machine engine sequentially performs transaction processing on the read transaction information according to the order in which the transaction information is read, thereby obtaining processing results corresponding to the plurality of pieces of transaction information.

In a feasible example, the virtual machine engine sends the plurality of pieces of transaction information and the processing results to the scheduling module, the plurality of pieces of transaction information and the processing results being configured for instructing the scheduling module to package the plurality of pieces of transaction information into a new block based on the processing results. The new block is a block added to the blockchain in the blockchain system after the consensus is completed, and the plurality of pieces of transaction information may be added to a block body of the new block. The processing results may be configured for updating state data in the blockchain system after the consensus is completed. A specific sending manner is as follows:

Sending of transaction information: a second transaction queue is set between the virtual machine engine and the scheduling module, the virtual machine engine sequentially writes the processed transaction information into a first-type write queue in the second queue, and the scheduling module sequentially reads the processed transaction information from a first-type read queue in the second transaction queue. A working principle of the second transaction queue is the same as a working principle of the transaction queue between the transaction pool module and the virtual machine engine.

Sending of processing results: when a result queue configured for transmitting the processing results includes a second-type read queue and a second-type write queue, the virtual machine engine writes the processing results into the second-type write queue. The second-type write queue is subject to a write lock constraint, the second-type write queue subject to the write lock constraint allows only a single thread to perform a write operation on the processing results at a same moment, the second-type read queue is used by the scheduling module to read the processing results, and the second-type read queue allows a plurality of threads to perform a read operation in parallel at a same moment. Specific operations are as follows: Obtain a read-write set identifier: The virtual machine engine determines, according to the transaction information corresponding to the processing results, a read-write set needed for processing the transaction information and the processing results corresponding to the transaction information, and obtains a read-write set identifier, such as a read-write set key, of the read-write set. Determining of write positions: Determine candidate sub-queues: Determine, for the sub-queues included in the second-type write queue, sub-queues whose read-write set identifiers are not the same as the read-write set identifiers of the processing results as candidate sub-queues. Determining of a target sub-queue: Determine a first candidate sub-queue of the candidate sub-queues as a target sub-queue. Determining of a write position in the target sub-queue: Determine write positions of the processing results in the target sub-queue according to the read-write set identifiers of the processing results, where the processing results in the sub-queue are sorted in ascending order of the read-write set identifiers. Determining of a write position in the second-type write queue: Determine the write positions of the processing results in the target sub-queue as the corresponding write positions of the processing results in the second-type write queue. Writing of the processing result: Write the processing results into the write positions, to write the processing results into the second-type write queue. If there is no candidate sub-queue in the second-type write queue, a new sub-queue is added to the tail of the second-type write queue and the processing results are written into the head of the new sub-queue.

A switching operation is performed between the sub-queue and the second-type read queue when the processing results in the second-type read queue are cleared. Specifically, the second-type read queue is moved to the tail of the second-type write queue, and the second-type read queue is changed to a new sub-queue, to obtain a new second-type write queue. Meanwhile, the first sub-queue in the second-type read queue is changed to a new second-type read queue. During the switching, all write operations and read operations on the processing results are forbidden, to avoid incorrect transmission of the processing results. After transmission of one batch of processing results (that is, the processing results of all the transaction information corresponding to the new block) is completed, the result queue may reserve a sub-queue (that is, restore to an initial state), to perform transmission of a next batch of processing results, thereby reducing occupation of the transmission resource by the result queue. The second-type read queue may also include a small number of sub-queues, for example, 2 or 3 sub-queues. This helps to reduce frequency of switching between a sub-queue and the second-type read queue, thereby reducing workload of managing the result queue. In addition, stable read of the processing results is ensured, and a read waiting time length is reduced, thereby improving efficiency of reading the processing results.

In the foregoing embodiments, the transaction queue is divided into the first-type write queue subject to the write lock constraint and the first-type read queue not subject to the lock constraint, thereby ensuring synchronization and consistency during write of the transaction information, and avoiding mutual impact of the read and write operations. The virtual machine engine may read transaction information in the first-type read queue in parallel without waiting for a write lock to be released, thereby improving read efficiency. The transaction pool module needs to occupy only the write lock to sequentially write the transaction information, and does not need to wait for the read lock to be released, thereby improving write efficiency, effectively improving transmission efficiency of the transaction information between the transaction pool module and the virtual machine engine, and finally improving efficiency of processing the transaction information in the blockchain node. Meanwhile, the scheduling module packages the transaction information into a new block based on the processing results, thereby ensuring normal running of the blockchain and orderly storage of transaction records.

In an example, that the first-type write queue is subject to the write lock constraint may be implemented as that the write lock is added to the first-type write queue. All threads need to occupy the write lock to perform the write operation on the transaction information for the first-type write queue. The write operation refers to a process of writing the transaction information into the first-type write queue. For example, if a write lock is added to a storage address corresponding to the first-type write queue, a thread needs to occupy the write lock to access and perform a write operation on the storage address to which the write lock is added. The write lock may be implemented as a segment of code. When the write lock is added, the first-type write queue is introduced to the segment of code. When the write lock is released, the first-type write queue is deleted from the segment of code. This is not limited in this embodiment.

In another example, a write lock may be added to a critical area (code or a program fragment configured for performing a write operation on the first-type write queue), and when a current thread occupies the critical area by using the write lock, other threads are blocked no matter whether the threads are configured for a write operation or a read operation. The read operation refers to a process of reading the transaction information from the first-type read queue. The critical area is code or a program fragment configured for performing a write operation on the first-type write queue. In a multi-threaded environment, to ensure synchronization and consistency of a shared resource (such as a first-type write queue), a write lock may be added to a critical area. When the front thread occupies the critical area by using the write lock, other threads are blocked no matter whether the threads perform a write operation or a read operation, to ensure that only a single thread is allowed to perform a write operation on the transaction information for the first-type write queue at the same moment, thereby avoiding data conflict and inconsistency.

In some embodiments, the first-type write queue may further include one or more sub-queues, and the one or more sub-queues are sequentially connected head to tail. Each sub-queue may be configured for writing transaction information. For example, the first sub-queue and the second sub-queue in the one or more sub-queues are configured for writing transaction information into the second sub-queue after the first sub-queue is filled up. For example, a quantity of the sub-queues may be preset according to an empirical value. For example, there are constantly 10 sub-queues, and the quantity of the sub-queues may also be adjusted in real time according to the written transaction information. For example, if 10 pieces of transaction information may be written into each sub-queue, each time 10 pieces of transaction information are written, a sub-queue is newly added to the tail of the first-type write queue. The length of the first-type write queue may also be automatically adjusted according to a quantity of pieces of written transaction information.

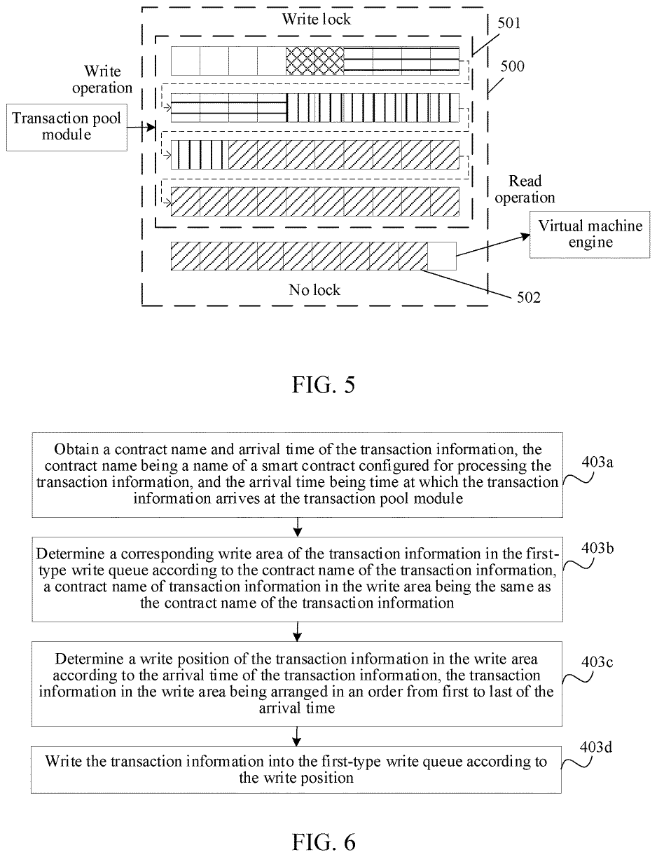

For example, FIG. 5 is a schematic diagram of a transaction queue according to an embodiment of this application. The transaction queue 500 includes a first-type write queue 501 and a first-type read queue 502. The first-type write queue 501 is not connected to the first-type read queue 502. A plurality of sub-queues in the first-type write queue 501 are connected head to tail, and lengths of the sub-queues may be the same. A length of the first-type read queue 502 may be the same as a length of a sub-queue.

The first-type write queue 501 is subject to a write lock constraint, and the first-type read queue 502 is not subject to a lock constraint. When a write thread intends to write transaction information into the first-type write queue 501, if it is detected that another write thread already occupies the write lock, the write thread waits for the another write thread to release the write lock. After the another write thread releases the write lock, the write thread may occupy the write lock and write the transaction information into the first-type write queue 501. If it is detected that the write lock is not occupied, the write thread may directly occupy the write lock, and write the transaction information into the first-type write queue 501.

When a read thread intends to read transaction information in the first-type read queue 502, regardless of whether another read thread is detected to be performing a read operation, the read thread may directly read the transaction information in the first-type read queue 502. Transaction information in the first-type read queue 502 is read by the virtual machine engine sequentially, for example, from the head to the tail of the first-type read queue 502 or from the tail to the head of the first-type read queue 502. A blank grid in FIG. 5 is configured for indicating that there is no transaction information at this position.

In an example, the transaction queue in an initial state includes a first-type read-write queue, the first-type read-write queue is subject to a read-write lock constraint, the first-type read-write queue subject to the read-write lock constraint allows only a single thread to perform a write operation at a same moment, and allows a plurality of threads to perform a read operation in parallel at a same moment. The transaction queue in an initial state includes a first-type read-write queue subject to a read-write lock constraint, the read-write lock constraint enables the first-type read-write queue to allow only a single thread to perform a write operation at a same moment, thereby ensuring consistency of written data, and to allow a plurality of threads to perform a read operation in parallel at a same moment, thereby improving read efficiency. Based on this, the claims further divide the transaction queue into a first-type write queue subject to a write lock constraint and a first-type read queue not subject to lock constraint, thereby further optimizing concurrent processing of read and write operations. This design ensures synchronization and consistency during write of the transaction information, and avoiding mutual impact of the read and write operations. The virtual machine engine may read transaction information in the first-type read queue in parallel without waiting for a write lock to be released, thereby improving read efficiency. The transaction pool module needs to occupy only the write lock to sequentially write the transaction information, and does not need to wait for the read lock to be released, thereby improving write efficiency, effectively improving transmission efficiency of the transaction information between the transaction pool module and the virtual machine engine, and finally improving efficiency of processing the transaction information in the blockchain node. Meanwhile, the scheduling module packages the transaction information into a new block based on the processing results, thereby ensuring normal running of the blockchain and orderly storage of transaction records.

The first-type read-write queue is not only configured for writing transaction information by a transaction pool module, but also configured for reading transaction information by a virtual machine engine. In some embodiments, a length of the first-type read-write queue may be the same as a length of the foregoing sub-queue, that is, a transaction queue in an initial state includes only one sub-queue.

In some embodiments, when a write thread (that is, the transaction pool module) intends to write transaction information into the first-type read-write queue, if it is detected that another write thread/read thread already occupies the read-write lock, the write thread waits for the another write thread/read thread to release the read-write lock. After the another write thread/read thread releases the read-write lock, the write thread may occupy the read-write lock (that is, the write lock) and write the transaction information into the first-type read-write queue. If it is detected that there is no other write thread or no read thread occupying the read-write lock, the write thread may directly occupy the read-write lock (that is, the write lock), and write the transaction information into the first-type read-write queue.

When the read thread (that is, the virtual machine engine) intends to read the transaction information from the first-type read-write queue, if it is detected that another write thread already occupies the read-write lock, the read thread waits for the another write thread to release the read-write lock. After the another write thread releases the read-write lock, the read thread may occupy the read-write lock (that is, the read lock) and read the transaction information from the first-type read-write queue. If it is detected that no other write thread occupies the read-write lock or a read thread occupies the read-write lock, the write thread may directly occupy the read-write lock (that is, a read lock), and read the transaction information from the first-type read-write queue.

In some embodiments, when the first-type read-write queue is filled up, a transaction queue in an initial state may be changed to a transaction queue in the foregoing state (which is recorded as a bidirectional multi-group sortable transaction queue, bidirectional: read and write; multi-group: including the first-type read queue and the first-type sub-queue; sortable: transaction information in the first-type read queue is sortable). For example, this embodiment may further include the following content:
1. Write transaction information into the first-type read-write queue.

In some embodiments, the transaction pool module may call the write thread to occupy the read-write lock, and sequentially write the transaction information into the first-type read-write queue starting from a first piece of transaction information in the foregoing plurality of pieces of transaction information.
2. Change the first-type read-write queue to the first-type read queue when the first-type read-write queue is filled up, and add the first-type write queue after the first-type read queue, the first-type write queue being not connected to the first-type read queue.

That the first-type read-write queue is filled up means that transaction information is written into each position corresponding to the first-type read-write queue. When the first-type read-write queue is changed to the first-type read queue, the read-write lock corresponding to the first-type read-write queue is released, and no lock is added to the first-type read queue. The write lock is added to the first-type write queue when the first-type write queue is added after the first-type read queue.

In some embodiments, the first-type write queue in the initial state includes only one sub-queue. As a quantity of pieces of written transaction information increases, the first-type write queue is expanded to include a plurality of sub-queues.

In this embodiment, the transaction queue in the initial state is set to include only one first-type read-write queue subject to a read-write lock constraint. When the quantity of transactions is relatively small, this setting can effectively reduce management workload of the transaction queue. However, when the quantity of written transactions is relatively large, and the first-type read-write queue is filled up, the first-type read-write queue is changed to the first-type read queue, and the first-type write queue is added, to switch to a bidirectional multi-group sortable transaction queue, thereby improving the transmission efficiency of the transaction information, implementing dynamic adjustment of the queue structure according to the transaction load, and optimizing the performance of the blockchain node.

In an example, a new sub-queue is added to a tail of the first-type write queue when the one or more sub-queues included in the first-type write queue are filled up, a head of the new sub-queue being connected to the tail of the first-type write queue.

For example, when one sub-queue included in the first-type write queue is filled up, a new sub-queue is added after the sub-queue; or when a plurality of sub-queues included in the first-type write queue is filled up, a new sub-queue is added after the last sub-queue. The length of the new sub-queue is the same as the length of the sub-queue included in the first-type write queue. Subsequent to-be-written transaction information may be written into the new sub-queue.

In this embodiment, when the one or more sub-queues of the first-type write queue are filled up, it means that as a quantity of pieces of written transaction information increases. In this case, a new sub-queue is added to the tail of the queue. Such a manner of adaptively adding a new sub-queue can ensure that all transaction information corresponding to a new block can be completely written into the transaction queue, and transmitted to the virtual machine engine for processing. In addition, the plurality of sub-queues provides a basis for conversion between the first-type read queue and the sub-queues, and facilitates subsequent queue management and efficient transmission of the transaction information, thereby improving overall performance of processing the transaction information by the blockchain node.

In the foregoing embodiments, by setting the transaction queue in the initial state to include only one first-type read-write queue, management workload of the transaction queue can be effectively reduced. When there are a relatively large quantity of written transactions, switching to a bidirectional multi-group sortable transaction queue can effectively improve the transmission efficiency of the transaction information.

In some embodiments, the transaction information in the transaction queue may be sorted. For example, the transaction information in the first-type write queue may be sorted. For example, the sorting may be implemented by the transaction pool module, or may be autonomously implemented by the transaction queue. This is not limited in this embodiment. For example, after determining the write position of the transaction information, the transaction pool module may directly add the transaction information to a corresponding write position in the first-type write queue. Alternatively, the transaction pool module may only add the transaction information to the first-type write queue, and the transaction queue autonomously sorts the transaction information, that is, automatically determines the write position of the transaction information in the first-type write queue. The write position is a position at which the transaction information is written in the first-type write queue.

For the transaction pool module and the transaction queue, methods for determining the write position are the same, and the transaction pool module is used as an example for description below. In an example, as shown in FIG. 6, operation 403 may further include the following sub-operations:

Operation 403a: Obtain a contract name and arrival time of the transaction information, the contract name being a name of a smart contract configured for processing the transaction information, and the arrival time being time at which the transaction information arrives at the transaction pool module.

In some embodiments, the transaction pool module determines, according to the contract address specified by the transaction information, a smart contract that needs to be called, and further determines a contract name of the transaction information. For example, if a name of a smart contract configured for processing transaction information A is B, B may be determined as a contract name of the transaction information.

The transaction pool module determines the arrival time of the transaction information according to the time at which the transaction information arrives at the transaction pool module. For example, if the transaction information reaches the transaction pool module at 20:17, 20:17 may be determined as the arrival time of the transaction information.

In some embodiments, the data configured for sorting transaction information is not limited to the foregoing contract name in this embodiment. Any identification information that can uniquely identify a smart contract may be configured for sorting transaction information.

Operation 403b: Determine a corresponding write area of the transaction information in the first-type write queue according to the contract name of the transaction information, a contract name of transaction information in the write area being the same as the contract name of the transaction information.

The write area refers to an area occupied by transaction information having the same contract name in the first-type write queue. Different contract names correspond to different write areas, and the write area may be identified by using a storage address corresponding to the write area. In some embodiments, pieces of transaction information in the same write area have the same contract name, that is, pieces of transaction information in the same write area are all processed by the same smart contract. Only after pieces of transaction information in one write area are processed by a corresponding smart contract, the smart contract is switched to process pieces of transaction information in a next write area. In this way, frequent switching of the smart contract can be avoided, thereby reducing switching costs of the smart contract, reducing response time consumption during switching of the smart contract, and further effectively improving transaction information processing efficiency.

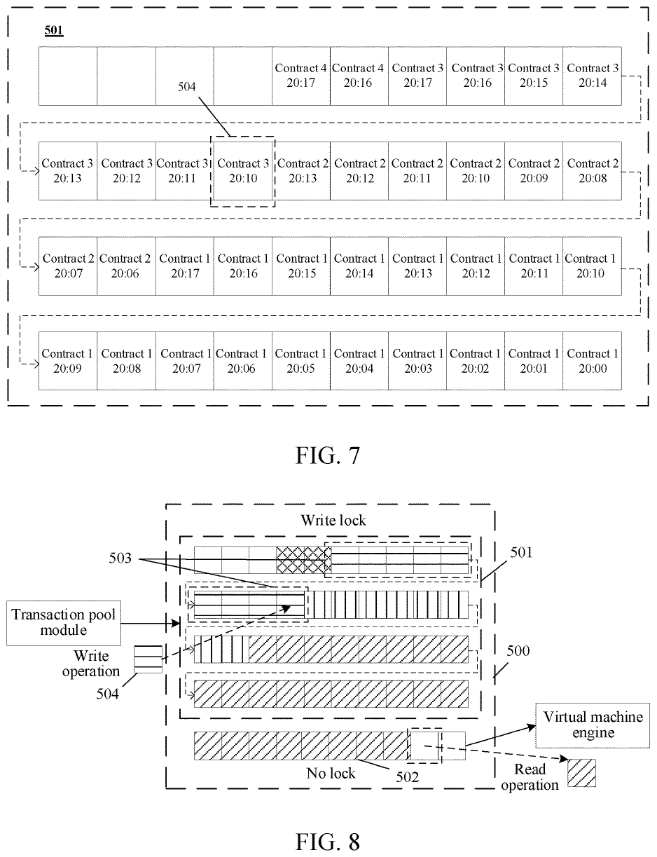

For example, referring to FIG. 7, the first-type write queue 501 includes 4 write areas: a write area corresponding to a contract 1, a write area corresponding to a contract 2, a write area corresponding to a contract 3, and a write area corresponding to a contract 4. Transaction information in each write area has the same contract name.

In some embodiments, when the first-type write queue has target transaction information whose contract name is the same as the contract name of the transaction information, a write area in which the target transaction information is located may be determined as the write area corresponding to the transaction information. The transaction information is written after last transaction information in the first-type write queue when the first-type write queue has no transaction information whose contract name is the same as the contract name of the transaction information, that is, a write area is newly added for the transaction information, and the write area is identified by using a contract name corresponding to the transaction information. In this way, when the first-type write queue has no transaction information whose contract name is the same as that of the current transaction information, that is, there is no corresponding write area, the transaction information is directly written after the last transaction information in the queue, that is, to the tail of the first-type write queue. By performing this operation, workload generated by adjusting the first-type write queue due to the transaction information can be effectively reduced, efficiency of writing the transaction information is improved, an unnecessary queue adjustment operation is avoided, and the transaction information can enter the queue more quickly and wait for processing.

For example, referring to FIG. 5 and FIG. 8, in a process in which the transaction pool module writes transaction information 504 into the first-type write queue 501, the transaction pool module may determine, according to a contract name of the transaction information 504, a write area 503 that corresponds to the transaction information 504 and that is in the first-type write queue 501, and the transaction pool module may write the transaction information 504 into the write area 503. The virtual machine engine may directly read the transaction information from the first-type read queue 502 without being affected by the write lock. In FIG. 5 and FIG. 8, grids having the same filling pattern form a write area, that is, transaction information corresponding to grids having the same filling pattern have the same contract name.

Operation 403c: Determine a write position of the transaction information in the write area according to the arrival time of the transaction information, the transaction information in the write area being arranged in an order from first to last of the arrival time.

In some embodiments, the arrival time of the transaction information is successively compared with those of pieces of transaction information in the write area, to determine a write position of the transaction information. For example, if the arrival time of the transaction information is earlier than the arrival time of the first piece of transaction information in the write area, a first position in the write area is determined as the write position of the transaction information; if the arrival time of the transaction information is earlier than the arrival time of the nth piece of transaction information in the write area and is later than the arrival time of the (n−1)^{th} piece of transaction information, a position corresponding to the nth piece of transaction information is determined as the write position of the transaction information, n being an integer greater than 1; and if the arrival time of the transaction information is later than the arrival time of the last transaction information in the write area, a position corresponding to transaction information after the last transaction information is determined as the write position of the transaction information.

For example, referring to FIG. 7 and FIG. 8 (FIG. 7 corresponds to FIG. 8, and FIG. 7 records a contract name and arrival time that correspond to each piece of transaction information in the first-type write queue 501), arrival time (20:10) of the transaction information 504 is earlier than arrival time (20:11) of the first piece of transaction information in the write area 503, and then the first position in the write area 503 may be determined as the write position of the transaction information 504.

In a feasible example, if the arrival time of the transaction information is earlier than the arrival time of the first piece of transaction information in the write area, a position (for example, a storage address) may be inserted before the first position in the write area, to be used as the write position of the transaction information; if the arrival time of the transaction information is earlier than the arrival time of the nth piece of transaction information in the write area and is later than the arrival time of the (n−1)^{th} piece of transaction information, a position may be inserted between a position corresponding to the nth piece of transaction information and a position corresponding to the (n−1)^{th} piece of transaction information, to be used as the write position of the transaction information; and if the arrival time of the transaction information is later than the arrival time of the last transaction information in the write area, a position may be inserted after a position corresponding to the last transaction information, to be used as the write position of the transaction information.

In some embodiments, pieces of transaction information after the write position and original transaction information at the write position may be sequentially moved backward by one position (that is, the storage address is adaptively changed), to reserve a write position for the foregoing transaction information. This is not limited in this embodiment.

For example, referring to FIG. 7 and FIG. 8, pieces of transaction information in the write area 503 and pieces of transaction information after the write area 503 are all sequentially moved backward by one position, to reserve a write position for the transaction information 504.

Operation 403d: Write the transaction information into the first-type write queue according to the write position.

In some embodiments, the transaction information is written into the write position, to write the transaction information into the first-type write queue. For example, referring to FIG. 7 and FIG. 8, the transaction information 504 may be directly written to the first position in the write area 503.

In this embodiment, the transaction information written into the first-type write queue is sorted according to the contract name and the arrival time, so that the transaction information can be processed in time (that is, for the same write area, transaction information whose arrival time is early is processed) while switching costs of the smart contract are reduced (response time consumption is reduced). The write area is determined according to the contract name, so that transaction information in the same write area is processed by the same smart contract. This manner can effectively reduce switching costs of a smart contract and reduce response time consumption during switching. In addition, transaction information in the write area is sorted according to arrival time, and transaction information whose arrival time is early is processed for the same write area, so that processing of the transaction information can be completed in time, thereby ensuring timeliness of processing the transaction information, and further improving efficiency of processing the transaction information.

In an example, this embodiment can further implement automatic sorting of the write area, pieces of transaction information in the write area may be collectively referred to as transaction groups, and the automatic sorting of the write area may be implemented as automatic sorting of the transaction groups.

For example, the transaction groups may be sorted based on transaction quantities of transaction information included in the transaction groups (the write areas), and the process may include the following content:
1. Obtain transaction quantities of transaction groups in the first-type write queue.

The obtaining transaction quantities of transaction groups is obtaining transaction quantities of transaction information in write areas that correspond to the transaction groups, where the transaction groups are obtained by clustering according to the contract name, and the transaction quantities are configured for indicating quantities of pieces of transaction information that are in the transaction groups and that are configured for transaction processing.

In some embodiments, the transaction pool module sorts the transaction groups each time a new piece of transaction information is written in the transaction queue; or when the transaction information in the first-type read queue is cleared, the transaction pool module sorts the transaction groups once, which is beneficial to reducing workload of sorting the transaction groups. This is not limited in this embodiment.
2. Sort the transaction groups in descending order of the transaction quantities, to obtain the adjusted first-type write queue.

In some embodiments, the transaction groups are sorted in descending order of the transaction quantities, to obtain a transaction group sequence, and the transaction groups are sequentially arranged according to the transaction group sequence, to obtain the adjusted first-type write queue. For example, a transaction group having a largest transaction quantity is placed at the head of the first-type write queue, and a transaction group having a smallest transaction quantity is placed at the tail of the first-type write queue. In this way, the transaction groups are sorted according to transaction quantities, and a smart contract having a relatively large transaction quantity is executed, so that frequent switching of the smart contract in a short time can be avoided as much as possible, thereby reducing a total response time length, further improving transaction contract processing efficiency, and enabling a blockchain node to process a large quantity of transaction information more efficiently.

For example, the transaction groups may be further sorted based on arrival time of transaction information included in the transaction groups (the write areas), and the process may include the following content:
1. Obtain earliest arrival time of transaction groups in the first-type write queue.

The transaction groups are obtained by clustering according to the contract name, and the earliest arrival time is earliest arrival time corresponding to pieces of transaction information that are configured for transaction processing and that are in the transaction groups.

In some embodiments, for each transaction group, the arrival time corresponding to pieces of transaction information in the transaction group is sorted in an order from first to last to obtain an arrival time sequence, and the first arrival time in the arrival time sequence is determined as the earliest arrival time corresponding to the transaction group.
2. Sort the transaction groups according to an order from first to last of the earliest arrival time, to obtain the adjusted first-type write queue.

In some embodiments, the transaction groups are sorted in an order of earliest arrival time from first to last, to obtain a transaction group sequence, and the transaction groups are sequentially arranged according to the transaction group sequence, to obtain the adjusted first-type write queue. For example, a transaction group having the first earliest arrival time is placed at the head of the first-type write queue, and a transaction group having the last earliest arrival time is placed at the tail of the first-type write queue. In this way, the transaction groups are sorted according to the arrival time, and transaction information whose arrival time is early is processed, which is beneficial to improving timeliness of processing the transaction information, and ensures that the transaction information whose arrival time is early can be processed, reduces waiting time of the transaction information, and improves the overall performance of the blockchain system.

In an example, when the transaction information in the first-type read queue is cleared, this embodiment may further include the following content:
1. Move the first-type read queue to the tail of the first-type write queue, and change the first-type read queue to a new sub-queue, to obtain a new first-type write queue.

Moving the first-type read queue to the tail of the first-type write queue refers to adding the first-type read queue to the last sub-queue in the first-type write queue, and connecting the first-type read queue to the last sub-queue. The new first-type write queue is used by the transaction pool module to write transaction information. For example, after the last sub-queue is filled up, the moved first-type read queue (that is, the new sub-queue) may be directly filled with the new transaction information.

In some embodiments, after the first-type read queue is moved to the tail of the first-type write queue, a write lock may be added to the first-type read queue, to convert the first-type read queue into a new sub-queue, thereby obtaining a new first-type write queue.

That the transaction information in the first-type read queue is cleared means that all the transaction information in the first-type read queue is read by the virtual machine engine, and after the transaction information in the first-type read queue is read by the virtual machine engine, the transaction pool module automatically deletes the transaction information to occupy no position.

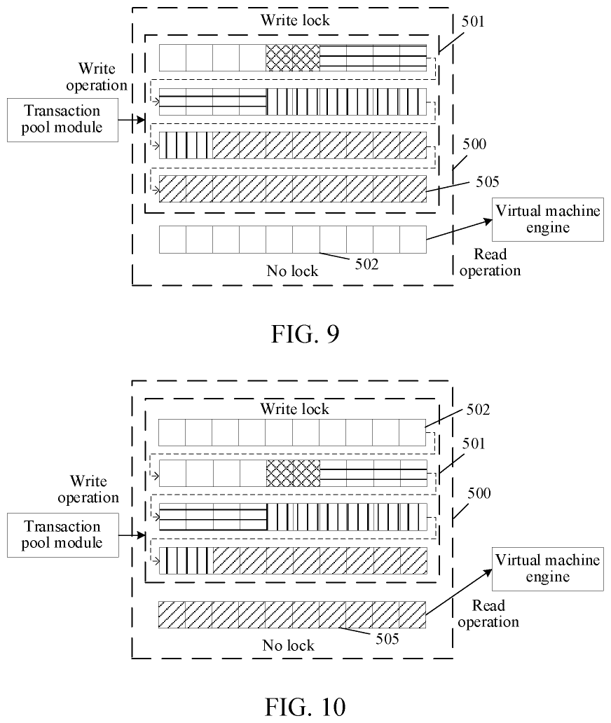

For example, referring to FIG. 9 and FIG. 10, for each piece of transaction information in the first-type read queue 502, after the transaction information is read by the virtual machine engine, the transaction pool module automatically deletes the transaction information. When the transaction information in the first-type read queue 502 is cleared, the first-type read queue 502 is moved to the tail of the first-type write queue 501, and the head of the moved first-type read queue 502 is connected to the first-type write queue 501. A write lock is added to the moved first-type read queue 502, to convert the first-type read queue 502 into a new sub-queue in the first-type write queue 501.
2. Change a first sub-queue in the first-type read queue to a new first-type read queue.

In some embodiments, the first sub-queue is disconnected from the second sub-queue in the first-type write queue, and the write lock of the first sub-queue is released, thereby changing the first sub-queue to a new first-type read queue. The new first-type read queue is used by the virtual machine engine to obtain the transaction information, that is, the virtual machine engine switches to read the transaction information from the new first-type read queue.

In the foregoing embodiments, when the transaction information in the first-type read queue is cleared, a switching operation between the sub-queue and the first-type read queue is performed, that is, the first-type read queue is moved to the tail of the first-type write queue and changed to a new sub-queue, and the first sub-queue in the first-type read queue is changed to a new first-type read queue. This switching manner is beneficial to continuously avoiding mutual impact between the write operation and the read operation, so that the write operation is performed in the new first-type write queue, and the read operation is performed in the new first-type read queue, thereby ensuring that a transmission process of the transaction information is not interfered with. In addition, this mechanism improves the transmission efficiency of the transaction information, so that the blockchain node can continuously and efficiently process the transaction information, thereby ensuring the smoothness and stability of transaction processing in the blockchain system.

In some embodiments, in a process of switching between the sub-queue and the first-type read queue, all write operations and read operations on the transaction information are forbidden, to avoid incorrect transmission of the transaction information.

For example, referring to FIG. 9 and FIG. 10, for the first sub-queue 505 in the first-type read queue, the first sub-queue 505 is disconnected from the second sub-queue in the first-type write queue 501, and the write lock of the first sub-queue 505 is released, to change the first sub-queue to a new first-type read queue. The virtual machine engine may continue reading the transaction information from the first sub-queue 505 without holding a lock.

In an example, the transaction information in the transaction queue may alternatively be pre-written. For example, transaction information of a sub-queue is pre-written, or transaction information less than a specified data volume is pre-written. The pre-written transaction information or the specified data volume may be determined according to a new block. This is not limited in this embodiment. Through pre-writing, the transmission efficiency of the transaction information can be further effectively improved.

In an example, after transmission of one batch of transaction information (that is, all the transaction information corresponding to the new block) is completed, the transaction queue may reserve a sub-queue (that is, restore to an initial state), to perform transmission of a next batch of transaction information. This helps to reduce occupation of a transmission resource by the transaction queue.

In an example, the first-type read queue may also include a small number of sub-queues, for example, 2 or 3 sub-queues. This helps to reduce frequency of switching between a sub-queue and the first-type read queue, thereby reducing workload of managing the transaction queue. In addition, stable read of the transaction information can be ensured, and a read waiting time length can be reduced, thereby improving efficiency of reading the transaction information.

The virtual machine engine is configured to obtain a processing result of transaction information, and the processing result is a result obtained by performing transaction processing on the transaction information (that is, executing a transaction). In some embodiments, the virtual machine engine may perform transaction processing on the transaction information by using the smart contract corresponding to the transaction information, to obtain the processing results of the transaction information.

In conclusion, by using the technical solution provided in this embodiment, in a process in which transaction information is transmitted in a blockchain node, a transaction queue is set to two types of queues: a write queue is configured for writing the transaction information, a read queue is configured for reading the transaction information, and the write queue is subject to a write lock constraint, thereby ensuring synchronization and consistency of the transaction information; and the read queue is not subject to a lock constraint, to avoid that a read operation on the transaction information is affected by a write operation on the transaction information, also avoid that a write operation on the transaction information is affected by a read operation on the transaction information, and effectively improve efficiency of a write operation on the transaction information and efficiency of a read operation on the transaction information, thereby improving efficiency of transmitting the transaction information in the blockchain node, and further improving efficiency of processing the transaction information in the blockchain node.

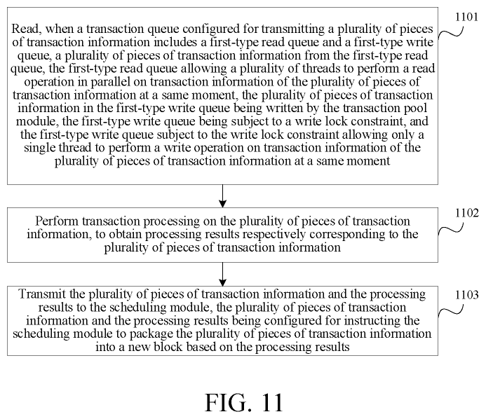

FIG. 11 is a flowchart of a transaction information processing method applied to a blockchain node according to another embodiment of this application. For example, the method may be performed by a blockchain node 101 in the solution implementation environment shown in FIG. 1, for example, a virtual machine engine 1015 in the blockchain node 101. As shown in FIG. 11, the method may include at least one of the following operations (1101 to 1103).

Operation 1101: Read, when a transaction queue configured for transmitting a plurality of pieces of transaction information includes a first-type read queue and a first-type write queue, a plurality of pieces of transaction information from the first-type read queue, the first-type read queue allowing a plurality of threads to perform a read operation in parallel on transaction information of the plurality of pieces of transaction information at a same moment, the plurality of pieces of transaction information in the first-type write queue being written by the transaction pool module, the first-type write queue being subject to a write lock constraint, and the first-type write queue subject to the write lock constraint allowing only a single thread to perform a write operation on transaction information of the plurality of pieces of transaction information at a same moment.

The transaction queue, the first-type read queue, the first-type write queue, the transaction information, the transaction pool module, and the virtual machine engine are the same as those described in the foregoing embodiments. For content not described in this embodiment, refer to the foregoing embodiment. Details are not described herein again.

In some embodiments, because the first-type read queue is not subject to a lock constraint, the virtual machine engine may read the transaction information from the first-type read queue by using at least a single thread simultaneously, without occupying the read lock, and without waiting for the write lock to be released. The transaction pool module needs to occupy a read lock, to sequentially write the transaction information into the first-type write queue. In an example, when the transaction queue includes only the first-type read-write queue, the virtual machine engine needs to occupy a read lock, to sequentially read the transaction information from the first-type read-write queue.

In some embodiments, the virtual machine engine may sequentially read the transaction information in an order from the head to the tail of the first-type read queue, and sequentially perform transaction processing on the read transaction information in the order.

Operation 1102: Perform transaction processing on the plurality of pieces of transaction information, to obtain processing results respectively corresponding to the plurality of pieces of transaction information.

In some embodiments, the virtual machine engine may perform transaction processing on the transaction information by using the smart contract corresponding to the transaction information, to obtain the processing results of the transaction information. A plurality of pieces of processed transaction information may be packaged into a new block.

Transaction processing may be performed on each piece of transaction information in the same transaction group (that is, the foregoing write area) by using the same smart contract. Transaction processing needs to be performed on transaction information in different transaction groups by switching to corresponding smart contracts. The virtual machine engine may sequentially perform transaction processing on the read transaction information according to the order in which the transaction information is read, to obtain processing results corresponding to the plurality of pieces of transaction information. Because the transaction information is sorted according to the contract name and the arrival time, such a practice can reduce switching costs of the smart contract, and reduce response time consumption during switching of the smart contract. The processing result is a result obtained by performing transaction processing on the transaction information (that is, executing a transaction).

Operation 1103: Transmit the plurality of pieces of transaction information and the processing results to the scheduling module, the plurality of pieces of transaction information and the processing results being configured for instructing the scheduling module to package the plurality of pieces of transaction information into a new block based on the processing results.

The new block is a block added to the blockchain in the blockchain system after the consensus is completed, and the plurality of pieces of transaction information may be added to a block body of the new block. The processing results may be configured for updating state data in the blockchain system after the consensus is completed.

In the foregoing embodiments, from the perspective of the virtual machine engine, when the transaction queue is divided into the first-type read queue and the first-type write queue, the virtual machine engine may read the transaction information from the first-type read queue without being subject to a lock constraint, thereby improving read efficiency. After transaction processing is performed on the read transaction information, the transaction information and a processing result are sent to a scheduling module and packaged into a new block, thereby ensuring normal processing of the transaction information and generation of the new block in the blockchain system. In addition, through a queue design of read-write separation, mutual impact of read and write operations is avoided, thereby improving transmission efficiency and processing efficiency of transaction information in a blockchain node.

In an example, the virtual machine engine may associate the transaction information and the processing result that corresponds to the transaction information together, and send the transaction information and the processing result to the scheduling module, for example, send the transaction information and the processing result to the scheduling module together by using the following result queue. Alternatively, the virtual machine engine may separately send the transaction information and the processing result to the scheduling module, for example, send the transaction information in a transaction queue manner and send the processing result in a result queue manner. This is not limited in this embodiment.

In a feasible example, the virtual machine engine may alternatively send the transaction information to the scheduling module by using a single queue, a remote procedure call (RPC) protocol, or the like. The transaction information between the transaction pool module and the virtual machine engine may also be transmitted by using a single queue, an RPC protocol, or the like. As long as the technical solution provided in this embodiment is applied to the virtual machine engine and the scheduling module, or the transaction pool module and the virtual machine engine, the transmission efficiency of the transaction information in the blockchain node can be improved. The RPC protocol is a manner that may be configured for transmitting transaction information between the virtual machine engine and the scheduling module, and between the transaction pool module and the virtual machine engine. The protocol allows a program on one computer to call a process or a function in a program on another computer, like calling a local program. In a blockchain system, the RPC protocol is configured for communication between different modules, and has an advantage of being convenient in use, where a developer may call a remote function like calling a local function, thereby improving development efficiency, and may further implement decoupling between different modules, thereby facilitating system extension and maintenance; and has a disadvantage in that a network delay affects calling performance, and needs to take measures to ensure security of communication and prevent data leakage and a malicious attack.

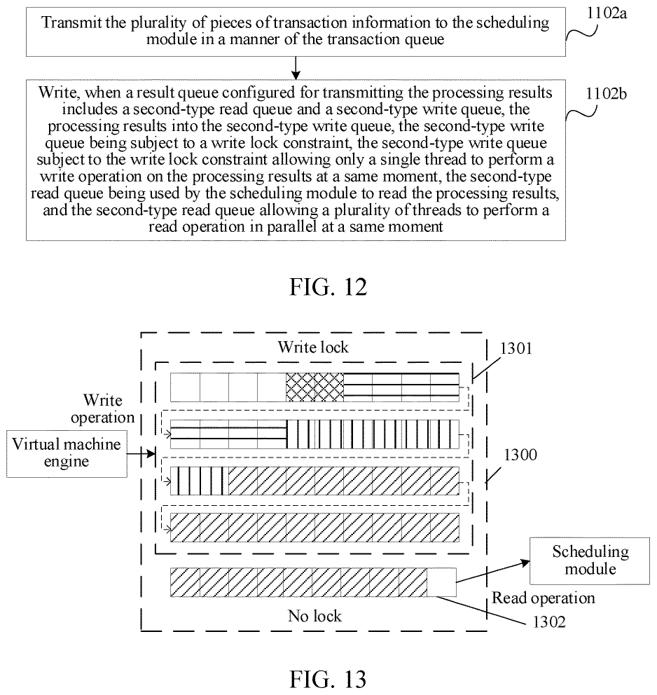

For example, as shown in FIG. 12, operation 1102 may further include the following sub-operations:

Operation 1102a: Transmit the plurality of pieces of transaction information to the scheduling module in a manner of the transaction queue.

In some embodiments, a second transaction queue is set between the virtual machine engine and the scheduling module. The virtual machine engine may sequentially write the processed transaction information into a first-type write queue in the second queue, and the scheduling module may sequentially read the processed transaction information from a first-type read queue in the second transaction queue. A working principle of the second transaction queue is the same as a working principle of the transaction queue between the transaction pool module and the virtual machine engine, and details are not described herein again.

Operation 1102b: Write, when a result queue configured for transmitting the processing results includes a second-type read queue and a second-type write queue, the processing results into the second-type write queue, the second-type write queue being subject to a write lock constraint, the second-type write queue subject to the write lock constraint allowing only a single thread to perform a write operation on the processing results at a same moment, the second-type read queue being used by the scheduling module to read the processing results, and the second-type read queue allowing a plurality of threads to perform a read operation in parallel at a same moment.

In this embodiment, the result queue is a queue configured for transmitting the processing result corresponding to the transaction information, for example, a queue configured for transmitting the processing result between the virtual machine engine and the scheduling module. The result queue in this embodiment is different from a common queue, and may include a second-type read queue and a second-type write queue. The second-type read queue refers to a queue configured for reading a processing result, and is not configured for writing a processing result. The second-type write queue refers to a queue configured for writing a processing result, and is not configured for reading a processing result. The second-type read queue is not connected to the second-type write queue. A data structure of the result queue is the same as a data structure of the transaction queue, and the result queue may also be referred to as a bidirectional multi-group sortable result queue.

In some embodiments, the second-type write queue is subject to a write lock constraint, and the second-type read queue is not subject to a lock constraint. The write lock is a write-lock in a read-write lock (a spin lock), there is only one read-write lock, and the write lock is a read-write lock performing locking in a write mode. The read-write lock is a synchronization primitive configured for protecting a shared resource, and allows a plurality of threads to simultaneously read the shared resource (a read lock), but allows only a single thread to perform a write operation (a write lock) when writing into the resource. The read-write lock can ensure that during a write operation, other threads cannot perform a read-write operation on the shared resource, thereby avoiding the problem of data inconsistency.

In the foregoing embodiments, the transaction information and the processing result are respectively transmitted through the transaction queue and the result queue. The result queue also adopts a design of read-write separation, that is, a second-type write queue subject to a write lock constraint and a second-type read queue not subject to lock constraint. Because the second-type write queue is subject to a write lock constraint, and the second-type read queue is not subject to a lock constraint, the scheduling module may read processing results in the second-type read queue by using threads in parallel, without occupying a read lock, and without waiting for the write lock corresponding to the second-type write queue to be released, thereby improving efficiency of reading the processing results. However, the virtual machine engine only needs to occupy the write lock and sequentially writes the processing results into the second-type write queue, and does not need to wait for the read lock (because the second-type read queue is not subject to a lock constraint) to be released, thereby improving efficiency of writing the processing results. This design ensures synchronization and consistency of the processing results when being written, effectively improves transmission efficiency of the processing results between the virtual machine engine and the scheduling module, and further improves overall performance of the blockchain node.

In an example, that the second-type write queue is subject to the write lock constraint may be implemented as that the write lock is added to the second-type write queue. All threads need to occupy the write lock to perform the write operation on the processing result for the second-type write queue. The write operation refers to a process of writing the processing result into the second-type write queue. For example, if a write lock is added to a storage address corresponding to the second-type write queue, a thread needs to occupy the write lock to access and perform a write operation on the storage address to which the write lock is added. The write lock may be implemented as a segment of code. When the write lock is added, the second-type write queue is introduced to the segment of code. When the write lock is released, the second-type write queue is deleted from the segment of code. This is not limited in this embodiment.

In another example, a write lock may be added to a critical area (code or a program fragment configured for performing a write operation on the second-type write queue), and when a current thread occupies the critical area by using the write lock, other threads are blocked no matter whether the threads are configured for a write operation or a read operation. The read operation refers to a process of reading the processing result from the second-type read queue.

In some embodiments, the second-type write queue may further include one or more sub-queues, and the one or more sub-queues are sequentially connected head to tail. Each sub-queue may be configured for writing a processing result. For example, the first sub-queue and the second sub-queue in the one or more sub-queues are configured for writing a processing result into the second sub-queue after the first sub-queue is filled up. For example, a quantity of the sub-queues may be preset according to an empirical value. For example, there are constantly 10 sub-queues, and the quantity of the sub-queues may also be adjusted in real time according to the written processing results. For example, if 10 processing results may be written into each sub-queue, each time 10 processing results are written, a sub-queue is newly added to the tail of the second-type write queue. The length of the second-type write queue may also be automatically adjusted according to a quantity of written processing results.

For example, FIG. 13 is a schematic diagram of a result queue according to an embodiment of this application. The result queue 1300 includes a second-type write queue 1301 and a second-type read queue 1302. The second-type write queue 1301 is not connected to the second-type read queue 1302. A plurality of sub-queues in the second-type write queue 1301 are connected head to tail, and lengths of the sub-queues may be the same. A length of the second-type read queue 1302 may be the same as a length of a sub-queue.

The second-type write queue 1301 is subject to a write lock constraint, and the second-type read queue 1302 is not subject to a lock constraint. When a write thread intends to write a processing result into the second-type write queue 1301, if it is detected that another write thread already occupies the write lock, the write thread waits for the another write thread to release the write lock. After the another write thread releases the write lock, the write thread may occupy the write lock and write the processing result into the second-type write queue 1301. If it is detected that the write lock is not occupied, the write thread may directly occupy the write lock, and write the processing result into the second-type write queue 1301.

When a read thread intends to read a processing result in the second-type read queue 1302, regardless of whether another read thread is detected to be performing a read operation, the read thread may directly read the processing result in the second-type read queue 1302. Processing results in the second-type read queue 1302 are read by the scheduling module sequentially, for example, from the head to the tail of the second-type read queue 1302 or from the tail to the head of the second-type read queue 1302. A blank grid in FIG. 13 is configured for indicating that there is no processing result at the position, and processing results corresponding to grids with the same filling pattern correspond to the same read-write set identifier.

In an example, the result queue in an initial state includes a second-type read-write queue, the second-type read-write queue is subject to a read-write lock constraint, the second-type read-write queue subject to the read-write lock constraint allows only a single thread to perform a write operation at a same moment, and allows a plurality of threads to perform a read operation in parallel at a same moment.

The second-type read-write queue is not only configured for the virtual machine engine to write the transaction information, but also configured for the scheduling module to read the transaction information. In some embodiments, a length of the second-type read-write queue may be the same as a length of the foregoing sub-queue, that is, a result queue in an initial state includes only one sub-queue.

In some embodiments, when the write thread (that is, the virtual machine engine) intends to write the processing result into the second-type read-write queue, if it is detected that another write thread/read thread occupies the read-write lock, the write thread waits for the another write thread/read thread to release the read-write lock. After the another write thread/read thread releases the read-write lock, the write thread may occupy the read-write lock (that is, the write lock), and write the processing result into the second-type read-write queue. If it is detected that there is no other write thread or no read thread occupying the read-write lock, the write thread may directly occupy the read-write lock (that is, the write lock), and write the processing result into the second-type read-write queue.

When the read thread (that is, the scheduling module) intends to read the processing result from the second-type read-write queue, if it is detected that another write thread already occupies the read-write lock, the read thread waits for the another write thread to release the read-write lock. After the another write thread releases the read-write lock, the read thread may occupy the read-write lock (that is, the read lock) and read the processing result from the second-type read-write queue. If it is detected that no other write thread occupies the read-write lock or a read thread occupies the read-write lock, the write thread may directly occupy the read-write lock (that is, a read lock), and read the processing result from the second-type read-write queue.

In some embodiments, when the second-type read-write queue is filled up, a result queue in an initial state may be changed to a result queue in the foregoing state (which is recorded as a bidirectional multi-group sortable result queue, bidirectional: read and write; multi-group: including the second-type read queue and the second-type sub-queue; sortable: processing results in the second-type read queue are sortable). For example, this embodiment may further include the following content:
1. Write the processing results into the second-type read-write queue.

In some embodiments, the virtual machine engine may call the write thread to occupy the read-write lock, and sequentially write the processing results into the second-type read-write queue starting from the first processing result in the processing results corresponding to the foregoing plurality of pieces of transaction information.
2. Change the second-type read-write queue to the second-type read queue when the second-type read-write queue is filled up, and add the second-type write queue after the second-type read queue, the second-type write queue being not connected to the second-type read queue.

That the second-type read-write queue is filled up means that a processing result is written into each position corresponding to the second-type read-write queue. When the second-type read-write queue is changed to the second-type read queue, the read-write lock corresponding to the second-type read-write queue is released, and no lock is added to the second-type read queue. The write lock is added to the second-type write queue when the second-type write queue is added after the second-type read queue.

In some embodiments, the second-type write queue in the initial state includes only one sub-queue. As a quantity of written processing results increases, the second-type write queue is expanded to include a plurality of sub-queues.

In an example, a new sub-queue is added to a tail of the second-type write queue when the one or more sub-queues included in the second-type write queue are filled up, a head of the new sub-queue being connected to the tail of the second-type write queue.

For example, when one sub-queue included in the second-type write queue is filled up, a new sub-queue is added after the sub-queue; or when a plurality of sub-queues included in the second-type write queue is filled up, a new sub-queue is added after the last sub-queue. The length of the new sub-queue is the same as the length of the sub-queue included in the second-type write queue. Subsequent to-be-written processing results may be written into the new sub-queue. As a quantity of written processing results increases, a new sub-queue is adaptively added, to ensure that processing results of all transaction information corresponding to one new block can be written into the result queue for transmission to the scheduling module. In addition, a plurality of sub-queues provide a basis for conversion between the second-type read queue and the sub-queue.

In this embodiment, the result queue in the initial state is set to include only one second-type read-write queue that is subject to the read-write lock constraint. When a quantity of processing results is relatively small, management workload of the result queue can be effectively reduced. As processing results increase, after the second-type read-write queue is filled up, the second-type write queue is changed to the second-type read queue, and the second-type write queue is added, to switch to a bidirectional multi-group sortable result queue. This dynamic adjustment manner not only considers management convenience when a load is low, but also improves transmission efficiency of the processing result when a load is high, thereby flexibly optimizing a queue structure according to a load of the processing result, and improving performance of processing the processing result by the blockchain node.

In some embodiments, the processing results in the foregoing result queue may be sorted. For example, the processing results in the second-type write queue may be sorted. For example, the sorting may be implemented by the virtual machine engine, or may be autonomously implemented by the result queue. This is not limited in this embodiment. For example, after determining write positions of the processing results, the virtual machine engine may directly add the processing results to corresponding write positions in the second-type write queue. Alternatively, the virtual machine engine may only add processing results to the second-type write queue, and the result queue autonomously sorts the processing results, that is, automatically determines the write positions of the processing results in the second-type write queue. The write position is a position at which the processing result is written in the second-type write queue.

For the virtual machine engine and the result queue, methods for determining the write position are the same, and the virtual machine engine is used as an example for description below. In an example, operation 1102b may further include the following content:
1. Obtain read-write set identifiers of the processing results, where the read-write set identifiers are configured for identifying read-write sets of transaction information corresponding to the processing results, and the read-write sets are configured for recording a status of access and modification by the transaction information corresponding to the processing results to state data of a blockchain system in which the blockchain node is located.

In some embodiments, the virtual machine engine determines, according to the transaction information corresponding to the processing results, a read-write set needed for processing the transaction information and the processing results corresponding to the transaction information, and obtains a read-write set identifier, such as a read-write set key, of the read-write set.
2. Determine corresponding write positions of the processing results in the second-type write queue according to the read-write set identifiers of the processing results.

In this embodiment, for sub-queues included in the second-type write queue, read-write set identifiers corresponding to processing results in the sub-queues may be made to be different as much as possible based on the read-write set identifiers of the processing results. In this way, processing results having different read-write set identifiers are processed as much as possible in a short time, and different read-write sets are accessed, thereby avoiding a read-write lock contention problem caused because a large quantity of processing results having the same read-write set identifier exist in the same sub-queue (for example, a read-write lock contention that may exist when the same read-write set is accessed), improving processing efficiency of the processing results, and improving transaction processing performance of the blockchain system.

For example, a process of determining corresponding write positions of the processing results in the second-type write queue may include the following content:
(1) Determine, for the sub-queues, sub-queues whose read-write set identifiers are not the same as the read-write set identifiers of the processing results as candidate sub-queues.

In some embodiments, by using a sub-queue as a unit, read-write set identifiers corresponding to sub-queues are compared with the read-write set identifiers of the processing results, to obtain candidate sub-queues.

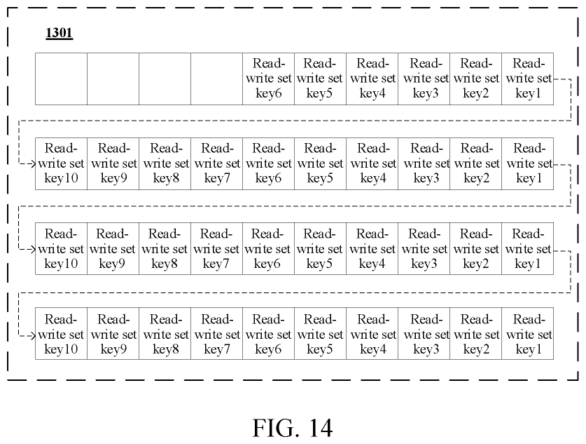

For example, referring to FIG. 14, the second-type write queue 1301 includes 4 sub-queues, the first sub-queue corresponds to a read-write set key1 to a read-write set key10, and read-write set keys corresponding to all positions are different. Each of the second sub-queue and the third sub-queue also corresponds to a read-write set key1 to a read-write set key10. The fourth sub-queue corresponds to a read-write set key 1 to a read-write set key6. If a read-write set identifier of a to-be-written processing result is any one of the read-write set key7 to the read-write set key10, the fourth sub-queue may be determined as a candidate sub-queue.
(2) Determine a first candidate sub-queue of the candidate sub-queues as a target sub-queue.

In some embodiments, when there is 1 candidate sub-queue, the candidate sub-queue may be directly determined as the target sub-queue. When a quantity of candidate sub-queues is 2 or more than 2, a first candidate sub-queue in the candidate sub-queues may be determined as the target sub-queue. The target sub-queue refers to a sub-queue into which a processing result is to be written. For example, referring to FIG. 14, the fourth sub-queue may be directly determined as the target sub-queue.
(3) Determine write positions of the processing results in the target sub-queue according to the read-write set identifiers of the processing results, where the processing results in the sub-queue are sorted in ascending order of the read-write set identifiers.

In some embodiments, a read-write set identifier of a processing result is compared with the read-write set identifiers of the processing results in the target sub-queue. if the read-write set identifier of the processing result is less than a read-write set identifier of a first processing result in the target sub-queue, a first position in the target sub-queue is determined as a write position of the processing result; and if the read-write set identifier of the processing result is less than a read-write set identifier of an nth processing result in the target sub-queue and is greater than a read-write set identifier of an (n−1)^{th} processing result, a position corresponding to the nth processing result is determined as a write position of the processing result, n being an integer greater than 1.

For example, referring to FIG. 14, if a read-write set identifier of a to-be-written processing result is the read-write set key7, a position after a processing result whose read-write set identifier is the read-write set key6 may be determined as a write position.

In some embodiments, processing results after the write position in the target sub-queue and an original processing result at the write position may be sequentially moved backward by one position (that is, the storage address is adaptively changed), to reserve a write position for the foregoing processing results. This is not limited in this embodiment.

For example, referring to FIG. 14, if a read-write set identifier corresponding to a fifth position in the fourth sub-queue is the read-write set key7, and a read-write set identifier of the to-be-written processing result is the read-write set key6, an original processing result at the fifth position is moved backward to a sixth position, and the fifth position is determined as a write position.

In an example, if positions in each sub-queue correspond to read-write set identifiers one to one, a position corresponding to a read-write set identifier may be directly determined as a write position. Referring to FIG. 14, if the read-write set identifier of the to-be-written processing result is the read-write set key8, the 8th position in the fourth sub-queue may be determined as the write position. This is not limited in this embodiment.

A sorting manner of the processing results in the sub-queue is not limited in this embodiment, and the processing results in the sub-queue may alternatively be arranged in descending order of the read-write set identifiers. The processing results in the sub-queue may alternatively not be arranged sequentially. This helps reduce a workload of writing the processing results, thereby improving efficiency of transmitting the processing results.
(4) Determine the write positions of the processing results in the target sub-queue as the corresponding write positions of the processing results in the second-type write queue.

For example, referring to FIG. 14, write positions of processing results in the fourth sub-queue are determined as the corresponding write positions of the processing results in the second-type write queue 1301.

When the second-type write queue includes a plurality of sub-queues, the candidate sub-queue and the target sub-queue are determined, and the write position of the processing result in the target sub-queue is determined in ascending order of the read-write set identifiers. This manner further optimizes storage and arrangement of the processing result in the second-type write queue, so that processing results of different read-write sets can be distributed in sub-queues more orderly, thereby reducing read-write lock conflicts, improving processing efficiency of the processing result, and enhancing stability and performance of the blockchain system.
3. Write the processing results into the second-type write queue according to the write positions.

In some embodiments, the processing results are written into the write positions, to write the processing results into the second-type write queue. In this embodiment, the sub-queue that is ranked top is filled up, to make it convenient to replace the second-type read queue for read of the processing result when the second-type read queue is cleared.

In the foregoing embodiments, a read-write set identifier of a processing result is obtained, and a write position of the processing result in the second-type write queue is determined according to the identifier. In this way, the processing result can be properly distributed in the second-type write queue according to the read-write set identifier, to avoid frequent contention between different processing results for the same read-write set, and ensure high efficiency and stability of writing the processing result, thereby improving the overall efficiency of processing transaction information and generating a new block by the blockchain system.

In an example, when there is no candidate sub-queue in the second-type write queue, a new sub-queue is added to the tail of the second-type write queue and the processing results are written into the head of the new sub-queue.

In this embodiment, when there is no candidate sub-queue in the second-type write queue, a new sub-queue is added to the tail of the queue and the processing results are written into the head of the new sub-queue. This processing manner can make the read-write set identifiers in the sub-queues as different as possible, thereby avoiding a problem of read-write lock contention, improving processing efficiency of a processing result, and ensuring that the blockchain system can efficiently process a large amount of transaction information.

For example, referring to FIG. 14, if the read-write set identifier of the to-be-written processing result is any one of the read-write set key1 to the read-write set key6, a new sub-queue may be added after the fourth sub-queue, to be used as a candidate sub-queue, and the processing result may be directly written into the head of the new sub-queue. In this way, by newly adding a sub-queue, read-write set identifiers in sub-queues may be made to be different as much as possible.

In an example, when the processing result in the second-type read queue is cleared, this embodiment may further include the following content:
1. Move the second-type read queue to the tail of the second-type write queue, and change the second-type read queue to a new sub-queue, to obtain a new second-type write queue.

Moving the second-type read queue to the tail of the second-type write queue refers to adding the second-type read queue to the last sub-queue in the second-type write queue, and connecting the second-type read queue to the last sub-queue. The new second-type write queue is used by the virtual machine engine to write the processing result. If the moved first-type read queue (that is, the new sub-queue) is the target sub-queue, the processing result may be written into the moved first-type read queue.

In some embodiments, after the second-type read queue is moved to the tail of the second-type write queue, a write lock may be added to the second-type read queue, to convert the second-type read queue into a new sub-queue, thereby obtaining a new second-type write queue. The new second-type write queue is used by the virtual machine engine of the blockchain node to write the processing results.

That the processing result in the second-type read queue is cleared means that all processing results in the second-type read queue are read by the scheduling module, and after the processing result in the second-type read queue is read by the scheduling module, the virtual machine engine automatically deletes the processing result to occupy no position.
2. Change a first sub-queue in the second-type read queue to a new second-type read queue.

In some embodiments, the first sub-queue is disconnected from the second sub-queue in the second-type write queue, and the write lock of the first sub-queue is released, thereby changing the first sub-queue to a new second-type read queue. The new second-type read queue is used by the scheduling module to read the processing result, that is, the scheduling module switches to read the processing result from the new second-type read queue.

In this embodiment, when the processing result in the second-type read queue is cleared, a switching operation between the sub-queue and the second-type read queue is performed, that is, the second-type read queue is moved to the tail of the second-type write queue and changed to a new sub-queue, and the first sub-queue in the second-type read queue is changed to a new second-type read queue. This switching manner is beneficial to continuously avoiding a problem of read-write lock contention, so that the write operation is performed in the new second-type write queue, and the read operation is performed in the new second-type read queue, thereby ensuring that a transmission process of the processing result is not interfered with. In addition, the mechanism greatly improves the transmission efficiency of the processing result, so that the blockchain node can continuously and efficiently process and transmit the processing result, thereby ensuring the smoothness and stability of flowing of the transaction processing result in the blockchain system, and further improving the performance and reliability of the entire blockchain system.

In some embodiments, during a process of switching between the sub-queue and the second-type read queue, all write operations and read operations on the processing results are forbidden, to avoid incorrect transmission of the processing results. A process of switching the sub-queue in the second-type write queue and the second-type read queue is the same as a process of switching the sub-queue in the first-type write queue and the first-type read queue described above. For content not described in this embodiment, refer to the foregoing embodiment, and details are not described herein again.

In an example, after transmission of one batch of processing results (that is, the processing results of all the transaction information corresponding to the new block) is completed, the result queue may reserve a sub-queue (that is, restore to an initial state), to perform transmission of a next batch of processing results, thereby helping reduce occupation of the transmission resource by the result queue.

In an example, the second-type read queue may also include a small number of sub-queues, for example, 2 or 3 sub-queues. This helps to reduce frequency of switching between a sub-queue and the second-type read queue, thereby reducing workload of managing the result queue. In addition, stable read of the processing results can be ensured, and a read waiting time length can be reduced, thereby improving efficiency of reading the processing results.

The scheduling module is configured to package a plurality of pieces of processed transaction information into a new block, and send the new block and the processing result to the consensus module, to complete a consensus between the new block and the processing result.

In conclusion, by using the technical solution provided in this embodiment, in a process in which transaction information is transmitted in a blockchain node, a transaction queue is set to two types of queues: a write queue is configured for writing the transaction information, a read queue is configured for reading the transaction information, and the write queue is subject to a write lock constraint, thereby ensuring synchronization and consistency of the transaction information; and the read queue is not subject to a lock constraint, to avoid that a read operation on the transaction information is affected by a write operation on the transaction information, also avoid that a write operation on the transaction information is affected by a read operation on the transaction information, and effectively improve efficiency of a write operation on the transaction information and efficiency of a read operation on the transaction information, thereby improving efficiency of transmitting the transaction information in the blockchain node, and further improving efficiency of processing the transaction information in the blockchain node.

In addition, in a process in which a processing result is transmitted in a blockchain node, a result queue is set to two types of queues: a write queue is configured for writing the processing result, a read queue is configured for reading the processing result, and the write queue is subject to a write lock constraint, thereby ensuring synchronization and consistency of the processing result; and the read queue is not subject to a lock constraint, to avoid that a read operation on the processing result is affected by a write operation on the processing result, also avoid that a write operation on the processing result is affected by a read operation on the processing result, and effectively improve efficiency of a write operation on the processing result and efficiency of a read operation on the processing result, thereby improving efficiency of transmitting the processing result in the blockchain node, and further improving efficiency of processing the processing result in the blockchain node.

An interaction process among the transaction pool module, the virtual machine engine, and the scheduling module are described below. For content not described in this embodiment, refer to the foregoing embodiment.
1. The transaction pool module is configured to: receive a transaction information transmission request transmitted by the scheduling module, the transaction information transmission request being configured for requesting the transaction pool module to start transmitting transaction information.
2. The transaction pool module is configured to determine, in response to the transaction information transmission request, a plurality of pieces of transaction information stored in the transaction pool module.
3. The transaction pool module is configured to write, when a transaction queue for transmitting the transaction information includes a first-type read queue and a first-type write queue, the transaction information into the first-type write queue, the first-type write queue being subject to a write lock constraint, the first-type write queue subject to the write lock constraint allowing only a single thread to perform a write operation on transaction information of the plurality of pieces of transaction information at a same moment, and the first-type read queue being not subject to lock constraint.

In an example, the transaction pool module is further configured to: obtain a contract name and arrival time of the transaction information, the contract name being a name of a smart contract configured for performing transaction processing on the transaction information, and the arrival time being time at which the transaction information arrives at the transaction pool module; determine a corresponding write area of the transaction information in the first-type write queue according to the contract name of the transaction information, a contract name of transaction information in the write area being the same as the contract name of the transaction information; determine a write position of the transaction information in the write area according to the arrival time of the transaction information, the transaction information in the write area being arranged in an order from first to last of the arrival time; and write the transaction information into the first-type write queue according to the write position.

In an example, the transaction pool module is further configured to: obtain transaction quantities of transaction groups in the first-type write queue, the transaction groups being obtained by clustering according to the contract name, and the transaction quantities being configured for indicating quantities of transaction information for transaction processing in the transaction groups; and sort the transaction groups in descending order of the transaction quantities, to obtain the adjusted first-type write queue.

In an example, the transaction pool module is further configured to: obtain earliest arrival time of transaction groups in the first-type write queue, the transaction groups being obtained by clustering according to the contract name, and the earliest arrival time being earliest arrival time corresponding to pieces of transaction information for transaction processing in the transaction groups; and sort the transaction groups according to an order from first to last of the earliest arrival time, to obtain the adjusted first-type write queue.

In an example, the transaction pool module is further configured to write the transaction information after last transaction information in the first-type write queue when the first-type write queue has no transaction information whose contract name is the same as the contract name of the transaction information.

In an example, the first-type write queue includes one or more sub-queues, and the one or more sub-queues are sequentially connected head to tail; and the transaction pool module is further configured to add a new sub-queue to a tail of the first-type write queue when the one or more sub-queues are filled up, a head of the new sub-queue being connected to the tail of the first-type write queue.

In an example, the transaction queue in an initial state includes a first-type read-write queue, the first-type read-write queue is subject to a read-write lock constraint, the first-type read-write queue subject to the read-write lock constraint allows only a single thread to perform a write operation at a same moment, and allows a plurality of threads to perform a read operation in parallel at a same moment; and the transaction pool module is further configured to: write transaction information into the first-type read-write queue; and change the first-type read-write queue to the first-type read queue when the first-type read-write queue is filled up, and add the first-type write queue after the first-type read queue, the first-type write queue being not connected to the first-type read queue.

In an example, the transaction pool module is further configured to: move the first-type read queue to the tail of the first-type write queue when transaction information in the first-type read queue is cleared, and change the first-type read queue to a new sub-queue, to obtain a new first-type write queue; and change a first sub-queue in the first-type read queue to a new first-type read queue, the new first-type read queue being used by the virtual machine engine to obtain the transaction information, and the new first-type write queue being used by the transaction pool module to write the transaction information.
4. The virtual machine engine is configured to: read the plurality of pieces of transaction information from the first-type read queue; and perform transaction processing on the plurality of pieces of transaction information, to obtain processing results respectively corresponding to the plurality of pieces of transaction information.
5. The virtual machine engine is configured to transmit the plurality of pieces of transaction information and the processing results that correspond to the plurality of pieces of transaction information to the scheduling module.

In an example, the virtual machine engine is further configured to send the plurality of pieces of transaction-processed transaction information to the scheduling module in a manner of the transaction queue; and write, when a result queue configured for transmitting the processing results includes a second-type read queue and a second-type write queue, the processing results into the second-type write queue, the second-type write queue being subject to a write lock constraint, the second-type write queue subject to the write lock constraint allowing only a single thread to perform a write operation on the processing results at a same moment, the second-type read queue being used by the scheduling module to read the processing results, and the second-type read queue allowing a plurality of threads to perform a read operation in parallel at a same moment.

In an example, the virtual machine engine is further configured to obtain read-write set identifiers of the transaction-processed processing results, where the read-write set identifiers are configured for identifying read-write sets of transaction information corresponding to the processing results, and the read-write sets are configured for recording a status of access and modification by the transaction information corresponding to the processing results to state data of a blockchain system in which the blockchain node is located; determine corresponding write positions of the processing results in the second-type write queue according to the read-write set identifiers of the processing results; and write the processing results into the second-type write queue according to the write positions.

In an example, the second-type write queue includes one or more sub-queues, and the one or more sub-queues are sequentially connected head to tail; and the virtual machine engine is further configured to determine, for the sub-queues, sub-queues whose read-write set identifiers are not the same as the read-write set identifiers of the processing results as candidate sub-queues; determine a first candidate sub-queue of the candidate sub-queues as a target sub-queue; determine write positions of the processing results in the target sub-queue according to the read-write set identifiers of the processing results, where the processing results in the sub-queue are sorted in ascending order of the read-write set identifiers; and determine the write positions of the processing results in the target sub-queue as the corresponding write positions of the processing results in the second-type write queue.

In an example, the virtual machine engine is further configured to add a new sub-queue to a tail of the second-type write queue when the candidate sub-queues do not exist in the second-type write queue; and write the processing results into a head of the new sub-queue.

In an example, the result queue in an initial state includes a second-type read-write queue, the second-type read-write queue is subject to a read-write lock constraint, the second-type read-write queue subject to the read-write lock constraint allows only a single thread to perform a write operation at a same moment, and allows a plurality of threads to perform a read operation in parallel at a same moment; and the virtual machine engine is further configured to write the processing results into the second-type read-write queue; and change the second-type read-write queue to the second-type read queue when the second-type read-write queue is filled up, and add the second-type write queue after the second-type read queue, the second-type write queue being not connected to the second-type read queue.

In an example, the virtual machine engine is further configured to move the second-type read queue to the tail of the second-type write queue when processing results in the second-type read queue are cleared, and change the second-type read queue to a new sub-queue, to obtain a new second-type write queue; and change a first sub-queue in the second-type read queue to a new second-type read queue, the new second-type read queue being used by the scheduling module to read the processing results, and the new second-type write queue being used by the virtual machine engine of the blockchain node to write the processing results.
6. The scheduling module is configured to package the plurality of pieces of transaction information into a new block.

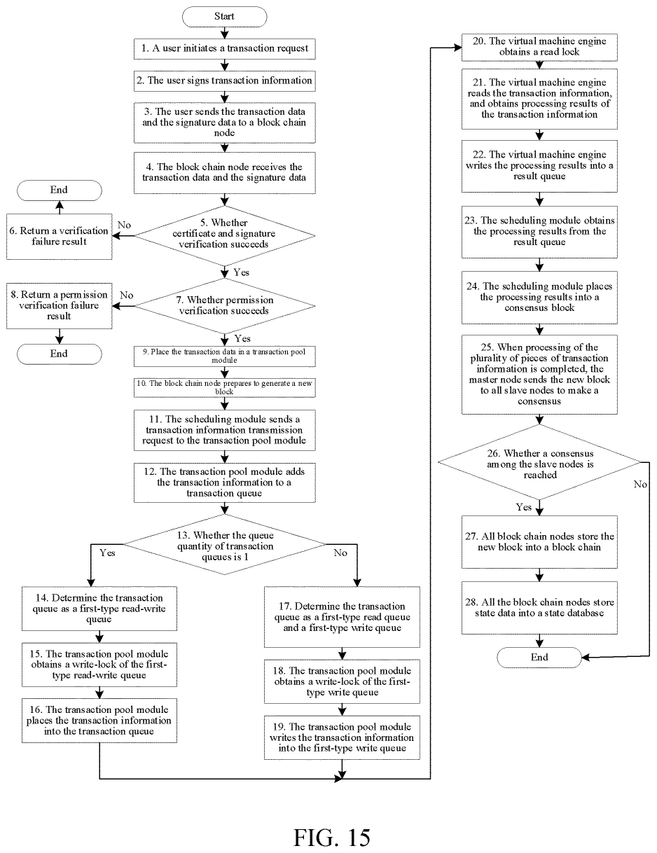

In some embodiments, referring to FIG. 15, a complete transaction processing process of a new block may include the following content:
1. A user initiates a transaction request by using a client.

The transaction request is configured for requesting to perform a transaction, and the client generates transaction data according to the transaction request.
2. The user signs transaction information corresponding to the transaction request.

The user may complete signature of the transaction information by using the client, and the client may generate signature data according to the signature of the user.
3. The user sends the transaction data and the signature data to a blockchain node.

In some embodiments, the user may send, by using the client, the transaction data and the signature data together to a blockchain node connected to the client.
4. The blockchain node receives the transaction data and the signature data.

The blockchain node may receive the transaction data and the signature data by using a network module.
5. The blockchain node performs certificate and the signature verification.

The blockchain node may perform certificate and signature verification on the transaction data by using a verification module. If the certificate and signature verification succeeds, go to 7. If the certificate and signature verification fails, go to 6.
6. Return a verification failure result to the client, and end.
7. The blockchain node performs permission verification.

The blockchain node may perform permission verification on the transaction data by using a verification module. If the permission verification succeeds, go to 9. If the permission verification fails, go to 8.
8. Return a permission verification failure result to the client, and end.
9. Place the transaction data in a transaction pool module.
10. The blockchain node prepares to generate a new block.

The blockchain node may prepare, based on a scheduling module, a new block that needs to be generated, for example, prepare a block header and a block body for the new block. The blockchain node may be referred to as a master node.
11. The scheduling module sends a transaction information transmission request to the transaction pool module.

The transaction information transmission request is configured for requesting the transaction pool module in the blockchain node to start transmitting a plurality of pieces of transaction information that needs to be packaged into the new block.
12. The transaction pool module adds the transaction information to a transaction queue.

The transaction pool module may sequentially write the foregoing plurality of pieces of transaction information into the transaction queue by using a transaction queue sender.
13. Whether the queue quantity of transaction queues is 1.

If the queue quantity of transaction queues is 1, go to 14. If the queue quantity of transaction queues is not 1, go to 17.
14. Determine the transaction queue as a first-type read-write queue.

That is, sending of the transaction information by the transaction pool module and reading of the transaction information by the virtual machine engine are both performed in the first-type read-write queue, and a lock (for example, a read-write lock) needs to be added for both a read operation and a write operation on the transaction information.
15. The transaction pool module obtains a write-lock of the first-type read-write queue.
16. The transaction pool module places the transaction information into the transaction queue, and goes to 20.
17. Determine the transaction queue as a first-type read queue and a first-type write queue.

The first-type read queue being used by the virtual machine engine to read the transaction information, and the first-type write queue being used by the transaction pool module to write the transaction information. The first-type write queue is subject to a write lock constraint, and the first-type read queue is not subject to a lock constraint.

The sub-queues in the first-type write queue are connected head to tail, the first sorting rule is a contract name of the transaction information, and it is ensured as much as possible that a contract group with a relatively large quantity of transactions is ranked top in the first-type write queue. In this way, frequently switching a smart contract by the virtual machine engine can be avoided. The second sorting rule is arrival time of transaction information, and it is ensured as much as possible that transaction information whose arrival time is early is ranked top in the contract group, to ensure timeliness of processing the transaction information.
18. The transaction pool module obtains a write-lock of the first-type write queue.
19. The transaction pool module writes the transaction information into the first-type write queue.

The transaction pool module may write the transaction information into the first-type write queue by using the transaction queue sender, and the first-type write queue automatically sorts the written transaction information.
20. The virtual machine engine obtains a read lock.

For the first-type read-write queue, the virtual machine engine obtains a read lock of the first-type read-write queue, to make it convenient to read the transaction information configured for transaction processing.
21. The virtual machine engine reads the transaction information, and performs transaction processing on the transaction information to obtain processing results.

When the virtual machine engine intends to read the transaction information from the first-type read-write queue, if it is detected that another write thread already occupies the read lock, the virtual machine engine waits for the another write thread to release the read lock. After the another write thread releases the read lock, the virtual machine engine may occupy the read lock and read the transaction information from the first-type read-write queue. For the first-type read queue, because the first-type read queue is not subject to a lock constraint, the virtual machine engine may directly read the transaction information from the first-type read queue by using a transaction queue reader.
22. The virtual machine engine writes the processing results into a result queue.

The virtual machine engine may write the processing results into a second-type write queue in the result queue by using a result queue sender. A data structure, a read-write lock, and usage of the result queue are respectively the same as the data structure, the read-write lock, and the usage of the transaction queue, but a sorting rule is different. The result queue mainly performs distinguishing sorting according to the read-write set key of the transaction information. That is, for sub-queues in the second-type write queue, it is ensured as much as possible that read-write set keys of pieces of transaction information in a sub-queue are different, thereby avoiding time consumption caused by lock contention.
23. The scheduling module reads the processing results from the result queue.

The scheduling module may read the processing results of the transaction information from a second-type read queue in the result queue by using a result queue reader.
24. The scheduling module places the processing results into a consensus block.
25. When processing of the plurality of pieces of transaction information is completed, the master node sends the new block to all slave nodes to make a consensus.

When processing of the plurality of pieces of transaction information is completed, the scheduling module may package the plurality of pieces of processed transaction information into a new block.
26. Whether a consensus among the slave nodes is reached.

If the consensus is reached, go to 27, and if the consensus is not reached, end.
27. All blockchain nodes store the new block into a blockchain.
28. All the blockchain nodes store state data into a state database.

The state data may be updated based on the processing results. End.

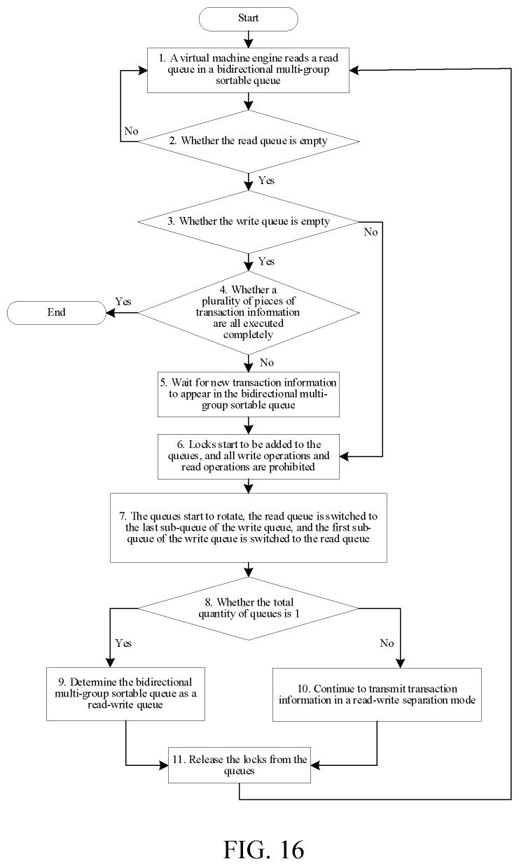

In some embodiments, the transaction queue and the result queue may be collectively referred to as bidirectional multi-group sortable queues, the first-type write queue and the second-type write queue are collectively referred to as write queues, and the first-type read queue and the second-type read queue are collectively referred to as read queues. Referring to FIG. 16, using an example in which a virtual machine engine obtains transaction information, a process of dynamically switching a write queue and a read queue may include the following content.
1. A virtual machine engine reads a read queue in a bidirectional multi-group sortable queue.
2. Whether the read queue is empty.

That is, whether the read queue is cleared is detected. If the read queue is empty, go to 3. If the read queue is not empty, go to 1.
3. Whether a write queue in the bidirectional multi-group sortable queue is empty.

If the write queue is empty, go to 4. If the write queue is not empty, go to 6.
4. Whether a plurality of pieces of transaction information are all executed completely.

If the plurality of pieces of transaction information are all executed completely, end. If the plurality of pieces of transaction information are not all executed completely, go to 5. The plurality of pieces of transaction information are packaged into a new block.
5. Wait for new transaction information to appear in the bidirectional multi-group sortable queue.
6. Locks start to be added to the queues, and all write operations and read operations are prohibited.

That is, when it is detected that the read queue is cleared, conversion between the read queue and the write queue may be started. In this case, neither the virtual machine engine nor a transaction pool module can operate the bidirectional multi-group sortable queue.
7. The queues start to rotate, the read queue is switched to the last sub-queue of the write queue, and the first sub-queue of the write queue is switched to the read queue.
8. Whether the total quantity of queues is 1.

The total quantity of queues is a total quantity of all sub-queues in the bidirectional multi-group sortable queue. If the total quantity of queues is 1, go to 9, and if the total quantity of queues is not 1, go to 10.
9. Determine the bidirectional multi-group sortable queue as a read-write queue, and go to 11.

That is, the bidirectional multi-group sortable queue is subject to a read-write lock constraint, and can be not only configured for writing transaction information, but also configured for reading transaction information.
10. Continue to transmit transaction information in a read-write separation mode.

That is, except one read queue, the remaining queues are all write queues, and the remaining queues are connected head to tail and are subject to a write lock constraint, while the read queue is not subject to a lock constraint.
11. Release the locks from the queues, and go to 1.

That is, in this case, both the virtual machine engine and the transaction pool module may operate the bidirectional multi-group sortable queue. End.

In some embodiments, the technical solution provided in this embodiment may be applied to at least the following several scenarios:
1. High-performance financial transaction processing: financial transaction processing has relatively high requirements on real-time performance, security, and throughput. The technical solutions provided in the embodiments of this application enable a blockchain system to process transaction information more efficiently, thereby improving transaction information processing performance, reducing switching costs during running of a smart contract, and reducing read-write lock conflicts. Therefore, the technical solutions provided in the embodiments of this application are very suitable for high-performance financial transaction processing scenarios, such as securities transactions, payment settlement, and cross-border remittance.
2. Supply chain financial and logistics management: Supply chain financial and logistics management involve participation of a plurality of parties, and have relatively high requirements on data consistency and real-time performance. The technical solutions provided in the embodiments of this application can ensure high efficiency and real-time performance of transaction processing, and facilitate improvement in operation efficiency of an entire supply chain financial and logistics management system. Application scenarios include supply chain financing, goods following, warehouse management, and the like.
3. Internet of Things data processing: a data volume generated by Internet of Things devices is huge, and has a high requirement on a data processing capability. According to the technical solutions provided in the embodiments of this application, the performance of the blockchain system in the Internet of Things data processing scenario is improved by using a read-write lock decoupling mechanism of a bidirectional multi-group sortable queue (such as a transaction queue and a result queue), a dynamic rotation mechanism, and an optimized sorting policy. Application scenarios include smart household, smart transportation, smart factory, and the like.
4. Cross-industry data sharing and privacy protection: Cross-industry data sharing and privacy protection involve multi-party data exchange, and have high requirements on a data processing capability and data security. The technical solutions provided in the embodiments of this application may improve performance of a blockchain system in processing a cross-industry data sharing and privacy protection scenario, and ensure data consistency and security. Application scenarios include medical data sharing, credit data sharing, intellectual property protection, and the like.

In conclusion, by using the technical solution provided in this embodiment, in a process in which transaction information is transmitted in a blockchain node, a transaction queue is set to two types of queues: a write queue is configured for writing the transaction information, a read queue is configured for reading the transaction information, and the write queue is subject to a write lock constraint, thereby ensuring synchronization and consistency of the transaction information; and the read queue is not subject to a lock constraint, to avoid that a read operation on the transaction information is affected by a write operation on the transaction information, also avoid that a write operation on the transaction information is affected by a read operation on the transaction information, and effectively improve efficiency of a write operation on the transaction information and efficiency of a read operation on the transaction information, thereby improving efficiency of transmitting the transaction information in the blockchain node, and further improving efficiency of processing the transaction information in the blockchain node.

In addition, in a process in which a processing result is transmitted in a blockchain node, a result queue is set to two types of queues: a write queue is configured for writing the processing result, a read queue is configured for reading the processing result, and the write queue is subject to a write lock constraint, thereby ensuring synchronization and consistency of the processing result; and the read queue is not subject to a lock constraint, to avoid that a read operation on the processing result is affected by a write operation on the processing result, also avoid that a write operation on the processing result is affected by a read operation on the processing result, and effectively improve efficiency of a write operation on the processing result and efficiency of a read operation on the processing result, thereby improving efficiency of transmitting the processing result in the blockchain node, and further improving efficiency of processing the processing result in the blockchain node.

The transaction information processing method for a blockchain node in this application involves three main modules: a scheduling module, a transaction pool module, and a virtual machine engine, whose workflow is as follows:

The scheduling module triggers. The scheduling module determines, according to a preset rule (such as a time interval or a transaction quantity), an occasion of generating a new block, generates a transaction information transmission request, and instructs the transaction pool module to start transmitting transaction information.

The transaction pool module processes the transaction information. Determine a to-be-processed transaction: after receiving the request, the transaction pool module determines, according to an identifier, a creation time, a current packaging time period, or the like in the request, a plurality of pieces of transaction information stored in the transaction pool module. Writing into a transaction queue: initially, the transaction queue includes a first-type read-write queue subject to a read-write lock constraint, and the transaction pool module calls a write thread to sequentially write the transaction information into the transaction queue. When the first-type read-write queue is filled up, the first-type read-write queue is changed to a first-type read queue, and a first-type write queue subject to a write lock constraint is added after the first-type read queue. Transaction information sorting: the transaction pool module obtains a contract name and arrival time of the transaction information, and determines a write area according to the contract name, to cause transactions in the same area to be processed by the same smart contract; and then determines a write position in the write area according to the arrival time, and processes a transaction that arrives early. In addition, the transaction groups may be sorted based on transaction quantities or earliest arrival time of the transaction groups. Dynamic queue adjustment: when a sub-queue of a first-type write queue is filled up, a new sub-queue is added at the tail. When the transaction information in the first-type read queue is cleared, the first-type read queue is moved to the tail of the first-type write queue and changed to a new sub-queue, and the first sub-queue of the first-type write queue is changed to a new first-type read queue.

The virtual machine engine processes a transaction. Read of transaction information: because the first-type read queue is not subject to a lock constraint, the virtual machine engine may read the transaction information from the first-type read queue by using threads in parallel. Execution of processing of a smart contract: transaction processing is performed on the read transaction information, to obtain the processing results. Transmission of transaction information and transaction results: the processed transaction information is sent to the scheduling module in a transaction queue manner; and when the result queue includes the second-type read queue and the second-type write queue, the processing results are written into the second-type write queue subject to the write lock constraint. Result queue management: the virtual machine engine obtains the read-write set identifiers of the processing results, determines the write positions of the processing results in the second-type write queue, and makes the read-write set identifiers of the processing results in the sub-queues different as much as possible, thereby reducing read-write lock contention. A new sub-queue is added at the tail when the second-type write queue has no suitable candidate sub-queue. When the processing results in the second-type read queue are cleared, queue switching is performed, and an operation is similar to that of the transaction queue.

The scheduling module performs packaging to obtain a new block. The scheduling module receives the plurality of pieces of transaction information and the processing results that are sent by the virtual machine engine, packages the transaction information into a new block based on the processing results, and then sends the new block and the processing results to the consensus module, to update the blockchain and the state data after the consensus is completed.

### Effects of this Application are as Follows

Transaction information transmission efficiency is improved: By using a queue design of read-write separation, the transaction queue is divided into a first-type write queue subject to a write lock constraint and a first-type read queue not subject to the lock constraint, and the result queue is divided into a second-type write queue subject to a write lock constraint and a second-type read queue not subject to the lock constraint. This design avoids mutual impact of read and write operations, the virtual machine engine may read a read queue without a lock in parallel, and the transaction pool module and the virtual machine engine only need to occupy a write lock to sequentially write information, thereby improving efficiency of reading and writing transaction information and a processing result, and further improving efficiency of transmitting the transaction information and the processing result in a blockchain node.

Switching costs of a smart contract are reduced: Transaction information is sorted according to a contract name and arrival time, and transactions in the same write area are processed by the same smart contract, thereby reducing frequent switching of the smart contract, reducing switching costs and response time consumption, and improving transaction information processing efficiency.

A read-write lock conflict is reduced: Read-write set identifiers of processing results in sub-queues are made to be different as much as possible by properly designing a queue structure and a sorting rule, for example, the result queues are sorted according to read-write set identifiers, thereby avoiding a problem of read-write lock contention caused by accessing the same read-write set, and improving processing efficiency of the processing results and transaction processing performance of a blockchain system.

Queue management is optimized: A queue structure in an initial state is simple; as a quantity of transactions or processing results increases, the queue structure is dynamically adjusted to a bidirectional multi-group sortable queue, and a sub-queue and a read queue are switched according to a queue state, so that not only management workload can be reduced when a load is low, but also transmission efficiency can be improved when a load is high, thereby flexibly optimizing a queue structure according to a load.

System stability and adaptability are enhanced: In an entire transaction processing process, modules work collaboratively, to ensure that the blockchain network can accurately and timely process a large amount of transaction information, and maintain normal operation of the network. The blockchain network is applicable to various scenarios such as high-performance financial transaction processing, supply chain financial and logistics management, Internet of Things data processing, cross-industry data sharing, and privacy protection.

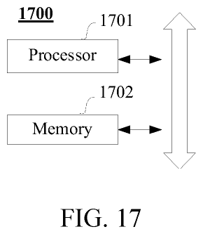

FIG. 17 is a block diagram of a structure of a computer device according to an embodiment of this application. The computer device may be implemented as the foregoing blockchain node.

Generally, a computer device 1700 includes a processor 1701 and a memory 1702.

The processor 1701 may include one or more processing cores, for example, may be a 4-core processor or an 8-core processor. The processor 1701 may be implemented in at least one hardware form of a Digital Signal Processor (DSP), a Field-Programmable Gate Array (FPGA), and a Programmable Logic Array (PLA). The processor 1701 may also include a main processor and a coprocessor. The main processor is a processor configured to process data in an awake state, and is also referred to as a central processing unit (CPU). The coprocessor is a processor with low power consumption configured to process data in a standby state. In some embodiments, the processor 1701 may be integrated with a graphics processing unit (GPU). The GPU is configured to render and draw content that needs to be displayed on a display. In some embodiments, the processor 1701 may further include an Artificial Intelligence (AI) processor. The AI processor is configured to process computing operations related to machine learning.

The memory 1702 may include one or more computer-readable storage media. The computer-readable storage media may be tangible and non-transitory. The memory 1702 may further include a high speed random access memory and a non-volatile memory, such as one or more disk storage devices and flash storage devices. In some embodiments, the non-transitory computer-readable storage medium in the memory 1702 has a computer program stored therein, and the computer program is loaded and executed by the processor 1701 to implement the transaction information processing method applied to a blockchain node provided in the foregoing method embodiments.

The embodiments of this application further provide a computer-readable storage medium. The storage medium has a computer program stored therein, and the computer program is loaded and executed by a processor to implement the transaction information processing method applied to a blockchain node provided in the foregoing method embodiments.

The computer-readable medium may include a computer storage medium and a communication medium. The computer storage medium includes volatile and non-volatile media, and removable and non-removable media implemented by any method or technology configured for storing information such as computer-readable instructions, data structures, program modules, or other data. The computer storage medium includes a random access memory (RAM), a read-only memory (ROM), an erasable programmable read-only memory (EPROM), an electrically erasable programmable read-only memory (EEPROM), a flash memory or another solid-state storage technology, a CD-ROM, a digital video disc (DVD) or another optical storage, a cassette, a magnetic tape, a disc storage or another magnetic storage device. Certainly, a person skilled in art can learn that the computer storage medium is not limited to the foregoing several types.

An embodiment of this application further provides a computer program product. The computer program product includes a computer program, the computer program is stored in a computer-readable storage medium, and a processor reads the computer program from the computer-readable storage medium and executes the computer program, to implement the transaction information processing method applied to a blockchain node according to the foregoing method embodiments.

In the embodiments of this application, before collection of relevant data of the user and during the collection of the relevant data of the user, a prompt interface or a pop-up window may be displayed, or audio prompt information may be outputted. The prompt interface, the pop-up window, or the audio prompt information is configured for prompting the user that the relevant data of the user is currently collected. In this way, in this application, only after a confirmation operation transmitted by the user for the prompt interface or the pop-up window is obtained, a relevant operation of obtaining the relevant data of the user is started to be performed. Otherwise (in other words, the confirmation operation transmitted by the user for the prompt interface or the pop-up window is not obtained), the relevant operation of obtaining the relevant data of the user is ended, in other words, the relevant data of the user is not obtained. In other words, all user data acquired in this application is strictly processed according to the requirements of relevant national laws and regulations. The informed consent or independent consent of a subject of personal information is acquired with consent and authorization of the user within the scope of authorization of the laws and regulations and the subject of the personal information. Subsequent data use and processing, and acquisition, use, and processing of the relevant user data are required to comply with relevant laws, regulations, and standards of relevant countries and areas. For example, the transaction information referred to in this application is all acquired under full authorization.

That “plurality of” mentioned in this specification means two or more. “And/or” describes an association relationship for describing associated objects and indicates that three relationships may exist. For example, A and/or B may indicate the following three cases: Only A exists, both A and B exist, and only B exists. The character “/” generally represents that the association objects before and after the character are in an “or” relationship.

The above are merely exemplary embodiments of this application, but are not intended to limit this application. Any modification, equivalent replacement, or improvement made within the spirit and principle of this application still fall within the scope of protection of this application.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this description provided that no conflict exists.

The foregoing embodiments only describe several implementations of this application specifically and in detail, but cannot be construed as a limitation to the patent scope of this application. For those of ordinary skill in the art, several transformations and improvements may further be made without departing from the idea of this application. These transformations and improvements fall within the scope of protection of this application. Therefore, the protection scope of this application is subject to the claims.

What is claimed is:

1. A transaction information processing method applied to a blockchain node comprising a scheduling module, a transaction pool module, and a virtual machine engine, and the method comprising:
receiving, by the scheduling module, a transaction information transmission request requesting the transaction pool module to start transmitting transaction information;
determining, in response to the transaction information transmission request, a plurality of pieces of transaction information stored in the transaction pool module; and
writing, when a transaction queue for transmitting the plurality of pieces of transaction information comprises a first-type read queue and a first-type write queue, the plurality of pieces of transaction information into the first-type write queue, wherein:
the first-type write queue is subject to a write lock constraint allowing only a single thread to perform a write operation on transaction information of the plurality of pieces of transaction information at a same moment;
the first-type read queue allows a plurality of threads to perform a read operation in parallel on transaction information of the plurality of pieces of transaction information at a same moment;
the first-type read queue is configured for the virtual machine engine to read transaction information of the plurality of pieces of transaction information and perform transaction processing on the plurality of pieces of transaction information to obtain processing results, and
the plurality of pieces of transaction information and the processing results are configured for instructing the scheduling module to package the plurality of pieces of transaction information into a new block based on the processing results.

2. The method according to claim 1, wherein the writing the plurality of pieces of transaction information into the first-type write queue comprises:
obtaining a contract name and arrival time of the transaction information, the contract name being a name of a smart contract for processing the transaction information, and the arrival time being time at which the transaction information arrives at the transaction pool module;
determining a corresponding write area of the transaction information in the first-type write queue according to the contract name of the transaction information, a contract name of transaction information in the write area being the same as the contract name of the transaction information;
determining a write position of the transaction information in the write area according to the arrival time of the transaction information, the transaction information in the write area being arranged in an order from first to last of the arrival time; and
writing the transaction information into the first-type write queue according to the write position.

3. The method according to claim 2, wherein after the writing the transaction information into the first-type write queue according to the write position, the method further comprises:
obtaining transaction quantities of transaction groups in the first-type write queue, the transaction groups being obtained by clustering according to the contract name; and
sorting the transaction groups in descending order of the transaction quantities, to obtain the adjusted first-type write queue.

4. The method according to claim 2, wherein after the writing the transaction information into the first-type write queue according to the write position, the method further comprises:
obtaining earliest arrival time of transaction groups in the first-type write queue, the transaction groups being obtained by clustering according to the contract name, and the earliest arrival time being earliest arrival time corresponding to pieces of transaction information in the transaction groups; and
sorting the transaction groups according to an order from first to last of the earliest arrival time, to obtain the adjusted first-type write queue.

5. The method according to claim 2, wherein the method further comprises:
writing the transaction information after last transaction information in the first-type write queue when the first-type write queue has no transaction information whose contract name is the same as the contract name of the transaction information.

6. The method according to claim 1, wherein the first-type write queue comprises one or more sub-queues, and the one or more sub-queues are sequentially connected head to tail; and the method further comprises:
adding a new sub-queue to a tail of the first-type write queue when the one or more sub-queues are filled up, a head of the new sub-queue being connected to the tail of the first-type write queue.

7. The method according to claim 1, wherein the transaction queue in an initial state comprises a first-type read-write queue, the first-type read-write queue is subject to a read-write lock constraint, the first-type read-write queue subject to the read-write lock constraint allows only a single thread to perform a write operation at a same moment, and allows a plurality of threads to perform a read operation in parallel at a same moment; and
before the writing the plurality of pieces of transaction information into the first-type write queue, the method further comprises:
writing the plurality of pieces of transaction information into the first-type read-write queue; and
changing the first-type read-write queue to the first-type read queue when the first-type read-write queue is filled up, and adding the first-type write queue after the first-type read queue, the first-type write queue being not connected to the first-type read queue.

8. The method according to claim 1, wherein after the writing the plurality of pieces of transaction information into the first-type write queue, the method further comprises:
moving the first-type read queue to the tail of the first-type write queue when transaction information in the first-type read queue is cleared, and changing the first-type read queue to a new sub-queue, to obtain a new first-type write queue; and
changing a first sub-queue in the first-type read queue to a new first-type read queue,
the new first-type read queue being used by the virtual machine engine to obtain the transaction information, and the new first-type write queue being used by the transaction pool module to write the transaction information.

9. A transaction information processing method applied to a blockchain node, the blockchain node comprising a scheduling module, a transaction pool module, and a virtual machine engine, and the method comprising:
reading, when a transaction queue configured for transmitting transaction information comprises a first-type read queue and a first-type write queue, a plurality of pieces of transaction information from the first-type read queue, wherein:
the first-type read queue allowing a plurality of threads to perform a read operation in parallel on transaction information of the plurality of pieces of transaction information at a same moment, the plurality of pieces of transaction information in the first-type write queue being written by the transaction pool module, the first-type write queue being subject to a write lock constraint, and the first-type write queue subject to the write lock constraint allowing only a single thread to perform a write operation on transaction information of the plurality of pieces of transaction information at a same moment;
performing transaction processing on the plurality of pieces of transaction information, to obtain processing results corresponding to the plurality of pieces of transaction information; and
transmitting the plurality of pieces of transaction information and the processing results to the scheduling module, the plurality of pieces of transaction information and the processing results being configured for instructing the scheduling module to package the plurality of pieces of transaction information into a new block.

10. The method according to claim 9, wherein the transmitting the plurality of pieces of transaction information and the processing results to the scheduling module comprises:
transmitting the plurality of pieces of transaction information to the scheduling module in a manner of the transaction queue; and
writing, when a result queue configured for transmitting the processing results comprises a second-type read queue and a second-type write queue, the processing results into the second-type write queue, the second-type write queue being subject to a write lock constraint, the second-type write queue subject to the write lock constraint allowing only a single thread to perform a write operation on the processing results at a same moment, the second-type read queue being used by the scheduling module to obtain the processing results, and the second-type read queue allowing a plurality of threads to perform a read operation in parallel at a same moment.

11. The method according to claim 10, wherein the writing the processing results into the second-type write queue comprises:
obtaining read-write set identifiers of the processing results, wherein the read-write set identifiers are configured for identifying read-write sets of transaction information corresponding to the processing results, and the read-write sets are configured for recording a status of access and modification by the transaction information corresponding to the processing results to state data of a blockchain system in which the blockchain node is located;
determining corresponding write positions of the processing results in the second-type write queue according to the read-write set identifiers of the processing results; and
writing the processing results into the second-type write queue according to the write positions.

12. The method according to claim 11, wherein the second-type write queue comprises one or more sub-queues, and the one or more sub-queues are sequentially connected head to tail; and
the determining corresponding write positions of the processing results in the second-type write queue according to the read-write set identifiers of the processing results comprises:
determining, for the sub-queues, sub-queues whose read-write set identifiers are not the same as the read-write set identifiers of the processing results as candidate sub-queues;
determining a first candidate sub-queue of the candidate sub-queues as a target sub-queue;
determining write positions of the processing results in the target sub-queue according to the read-write set identifiers of the processing results, wherein the processing results in the sub-queue are sorted in ascending order of the read-write set identifiers; and
determining the write positions of the processing results in the target sub-queue as the corresponding write positions of the processing results in the second-type write queue.

13. The method according to claim 12, wherein the method further comprises:
adding a new sub-queue to a tail of the second-type write queue when the candidate sub-queues do not exist in the second-type write queue; and
writing the processing results into a head of the new sub-queue.

14. The method according to claim 10, wherein the result queue in an initial state comprises a second-type read-write queue, the second-type read-write queue is subject to a read-write lock constraint, the second-type read-write queue subject to the read-write lock constraint allows only a single thread to perform a write operation at a same moment, and allows a plurality of threads to perform a read operation in parallel at a same moment; and
before the writing the processing results into the second-type write queue, the method further comprises:
writing the processing results into the second-type read-write queue; and
changing the second-type read-write queue to the second-type read queue when the second-type read-write queue is filled up, and adding the second-type write queue after the second-type read queue, the second-type write queue being not connected to the second-type read queue.

15. The method according to claim 10, wherein after the writing the processing results into the second-type write queue, the method further comprises:
moving the second-type read queue to the tail of the second-type write queue when processing results in the second-type read queue are cleared, and changing the second-type read queue to a new sub-queue, to obtain a new second-type write queue; and
changing a first sub-queue in the second-type read queue to a new second-type read queue,
wherein the new second-type read queue is used by the scheduling module to obtain the processing results, and the new second-type write queue is used by the virtual machine engine of the blockchain node to write the processing results.

16. A non-transitory computer-readable storage medium, the storage medium having a computer program stored therein, the computer program being loaded and executed by a processor to implement a transaction information processing method applied to a blockchain node, and the method comprising:
receiving, by the scheduling module, a transaction information transmission request requesting the transaction pool module to start transmitting transaction information;
determining, in response to the transaction information transmission request, a plurality of pieces of transaction information stored in the transaction pool module; and
writing, when a transaction queue for transmitting the plurality of pieces of transaction information comprises a first-type read queue and a first-type write queue, the plurality of pieces of transaction information into the first-type write queue, wherein:
the first-type write queue is subject to a write lock constraint allowing only a single thread to perform a write operation on transaction information of the plurality of pieces of transaction information at a same moment;
the first-type read queue allows a plurality of threads to perform a read operation in parallel on transaction information of the plurality of pieces of transaction information at a same moment;
the first-type read queue is configured for the virtual machine engine to read transaction information of the plurality of pieces of transaction information and perform transaction processing on the plurality of pieces of transaction information to obtain processing results, and
the plurality of pieces of transaction information and the processing results are configured for instructing the scheduling module to package the plurality of pieces of transaction information into a new block based on the processing results.

17. The computer-readable storage medium according to claim 16, wherein the writing the plurality of pieces of transaction information into the first-type write queue comprises:
obtaining a contract name and arrival time of the transaction information, the contract name being a name of a smart contract for processing the transaction information, and the arrival time being time at which the transaction information arrives at the transaction pool module;
determining a corresponding write area of the transaction information in the first-type write queue according to the contract name of the transaction information, a contract name of transaction information in the write area being the same as the contract name of the transaction information;
determining a write position of the transaction information in the write area according to the arrival time of the transaction information, the transaction information in the write area being arranged in an order from first to last of the arrival time; and
writing the transaction information into the first-type write queue according to the write position.

18. The computer-readable storage medium according to claim 17, wherein after the writing the transaction information into the first-type write queue according to the write position, the method further comprises:
obtaining transaction quantities of transaction groups in the first-type write queue, the transaction groups being obtained by clustering according to the contract name; and
sorting the transaction groups in descending order of the transaction quantities, to obtain the adjusted first-type write queue.

19. The computer-readable storage medium according to claim 17, wherein after the writing the transaction information into the first-type write queue according to the write position, the method further comprises:
obtaining earliest arrival time of transaction groups in the first-type write queue, the transaction groups being obtained by clustering according to the contract name, and the earliest arrival time being earliest arrival time corresponding to pieces of transaction information in the transaction groups; and
sorting the transaction groups according to an order from first to last of the earliest arrival time, to obtain the adjusted first-type write queue.

20. The computer-readable storage medium according to claim 17, wherein the method further comprises:
writing the transaction information after last transaction information in the first-type write queue when the first-type write queue has no transaction information whose contract name is the same as the contract name of the transaction information.
